(19) United States
(12) Patent Application Publication
(10) Pub. No.: US 2021/0120813 A1
(43) Pub. Date: Apr. 29, 2021

(54) INHIBITORS OF THE SHIKIMATE PATHWAY

(71) Applicant: PEPTICOM LTD., Jerusalem (IL)

(72) Inventors: Itsik BAR-NAHUM, Kfar-Gibton (IL); Yaniv BARDA, Rehovot (IL); Sami SHABTAI, Omer (IL); Noam SHEFFER, Herzliya (IL); Danny KARMON, Gan Hashomron (IL); Limor PORATY-GAVRA, Rehovot (IL); Amit MICHAELI, Jerusalem (IL); Immanuel LERNER, Jerusalem (IL); Shaul MEZAN, Modiin (IL); Alex KILSHTAIN-VARDI, Rehovot (IL); Maayan ELIAS ROBICSEK, Oranit (IL)

(21) Appl. No.: 17/254,613

(22) PCT Filed: Jun. 24, 2019
(86) PCT No.: PCT/IB2019/055315

§ 371 Date: Dec. 21, 2020

Related U.S. Application Data
(60) Provisional application No. 62/689,676, filed on Jun. 25, 2018.

(51) Int. Cl. A01N 37/48; A01N 37/40; A01N 43/38; A01N 57/20

(52) U.S. Cl. CPC A01N 37/48; A01N 57/20; A01N 43/38; A01N 37/40

(57) ABSTRACT

The present invention provides pesticidal compositions comprising an agriculturally acceptable carrier and at least one compound of Formula (A) or a salt thereof as described herein. The present invention also provides methods for the control or prevention of pest in a crop field, comprising applying the compound(s) of Formula (A) or pesticidal compositions thereof to the pest, a locus of the pest and/or an area in which pest infestation is to be prevented so as to thereby control or prevent pest in the crop field.

This application claims benefit of U.S. Provisional Application No. 62/689,676, filed Jun. 25, 2018, the entire content of which is hereby incorporated by reference herein.

Throughout this application, various publications are cited. Disclosures of the documents and publications referred to herein are hereby incorporated in their entireties by reference into this application.

### BACKGROUND OF THE INVENTION

### 1. Technical Field

The present invention relates to the field of biochemistry, and more particularly, to compounds that inhibit the enzymatic activity of: a) 5-enolpyruvylshikimate-3-phosphate synthase (EPSPS) and b) shikimate kinase, as well as to the effect of this inhibition on microorganisms and plants.

### 2. Discussion of Related Art

The shikimate pathway is used mainly by microorganisms (for example bacteria and fungi) and plants in the biosynthesis of aromatic amino acids. Shikimate kinase and EPSPS are two key enzymes in the shikimate pathway. Shikimate kinase catalyzes the phosphorylation of shikimate to form shikimate 3-phosphate. EPSPS catalyzes the transfer of an alkyl group from phosphoenolpyruvate (PEP) to shikimate-3-phosphate, yielding phosphate and 5-enolpyruvylshikimate-3-phosphate.

Inhibitors of shikimate kinase and EPSPS may have significant value in the field of agriculture as pesticides, such as bactericides, fungicides and herbicides. For example, the inhibition of EPSPS by glyphosate (N-(phosphonomethyl)glycine) is of great importance in the field of agriculture. Glyphosate is a broad-spectrum herbicide and acts by competitively inhibiting PEP binding to EPSPS.

Novel inhibitors of shikimate kinase and/or EPSPS are of particular need in the art. Approximately 80% of the total area devoted to transgenic crops has been planted with herbicide-resistant crops, which are all resistant to glyphosate. However, due to the overuse of this single technology, weed resistance to glyphosate has also emerged over the last few years by several mechanisms. One central mechanism of weed resistance to glyphosate is due to point mutations in the EPSPS enzyme. These mutations are centered within the binding pocket of PEP in the EPSPS enzyme and most involve substitutions of threonine 102 and proline 106. Given the importance of glyphosate as a broad-spectrum herbicide in the agrochemical industry, the economic effects of the increasing resistance of weeds to glyphosate is of great concern.

An object of the present invention is thus to provide herbicidal compound(s) that can effectively control or prevent weeds-growth (wild type/conventional) and glyphosate-resistant weeds. Another object is to provide stable pesticidal compositions comprising these active compounds.

### SUMMARY OF THE INVENTION

The subject invention provides a pesticidal composition comprising an agriculturally acceptable carrier and at least one compound of Formula (A)

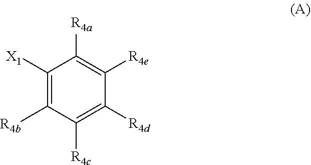

wherein
X₁ is H, alkyl of C₁-C₁₂, OR₁, COR₂, SR₁, NO₂, halogen, CH₂F, CHF₂, CF₃, N—(—R₃)₂, CN, SO₂R₂, or

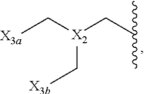

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃ₐ and X_{3b} is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or R₄ₑ forms a five-membered fused ring with R_{4d},
   or a salt thereof.

The subject invention provides a pesticidal composition comprising an agriculturally acceptable carrier and (i) at least one compound of Formula (I)

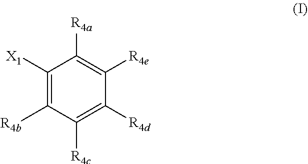

wherein
X₁ is H, alkyl of C₁-C₁₂, OR₁, COR₂, SR₁, NO₂, halogen, CH₂F, CHF₂, CF₃, N—(—R₃)₂, CN, SO₂R₂, or

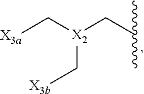

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or a salt thereof;
   or (ii) at least one compound of Formula (II)

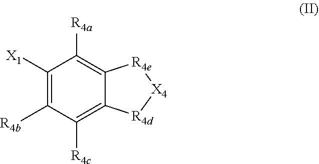

wherein
X₁ is H, alkyl C₁-C₁₂, OR₁, COR₂, SR₁, NO₂, halogen, CH₂F, CHF₂, CF₃, N—(—R₃)₂, CN, SO₂R₂ or

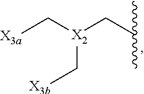

wherein
R₁ is H, alkyl, alkenyl, alkynyl of C₁-C₁₀, CO-alkyl, CO-alkenyl, CO-alkynyl of C₁-C₁₀, CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃ₐ and X_{3b} is, independently, COOH, PO₃H₂ or NO₂;
each of R₄ₐ, R_{4b} and R_{4c} is, independently, H, alkyl, alkenyl, alkynyl of C₁-C₃, OR₅, COR₆, SR₅, NO₂, halogen, CH₂F, CHF₂, CF₃, NR₇R₈, CN, or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
and
R₄ₑ forms a five-membered fused ring with R_{4d} and X₄,
   wherein
   each of R₄ₑ, R_{4d} and X₄ is, independently C(R₉)₂, C(O), NR₉, O, S, SO, or SO₂,
   wherein
   R₉ is H, OH, O-alkyl, O-alkenyl, O-alkynyl of C₁-C₃, alkyl, alkenyl, or alkynyl of C₁-C₃;
or a salt thereof.

The present invention also provides a method for the control or prevention of pest in a crop field, comprising applying a pesticidally effective amount of any one of the pesticidal compositions disclosed herein to the pest, a locus of the pest and/or an area in which pest infestation is to be prevented so as to thereby control or prevent pest in the crop field.

The present invention also provides a method for the control or prevention of pest in a crop field, comprising applying a pesticidally effective amount of (i) at least one compound of Formula (I) or a salt thereof as described herein, or (ii) at least one compound of Formula (II) or a salt thereof as described herein to the pest, a locus of the pest and/or an area in which pest infestation is to be prevented so as to thereby control or prevent pest in the crop field.

The present invention also provides a method of inhibiting 5-enolpyruvylshikimate-3-phosphate synthase (EPSPS) and/or its mutant by using (i) at least one of the compounds of Formula (I) or a salt thereof as described herein, or (ii) at least one of the compounds of Formula (II) or a salt thereof as described herein.

The present invention also provides a method of inhibiting shikimate kinase by using (i) at least one of the compounds of Formula (I) or a salt thereof as described herein, or (ii) at least one of the compounds of Formula (II) or a salt thereof as described herein.

The present invention also provides a method for the control or prevention of pest in a crop field, comprising applying a pesticidally effective amount of at least one compound of Formula (A) or a salt thereof as described herein to the pest, a locus of the pest and/or an area in which pest infestation is to be prevented so as to thereby control or prevent pest in the crop field.

The present invention also provides a method of inhibiting 5-enolpyruvylshikimate-3-phosphate synthase (EPSPS) and/or its mutant by using at least one of the compounds of Formula (A) or a salt thereof as described herein.

The present invention also provides a method of inhibiting shikimate kinase by using at least one of the compounds of Formula (A) or a salt thereof as described herein.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

FIG. 1: shows small molecule inhibitory effect on mutant EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (TIPS mutant) from common wheat (Triticum Aestivum) into E. coli bacterial line AB2829, using 0.1% rhamnose, rescues the growth phenotype (Rescue)(Set as 100% growth). Introducing the TIPS mutant of EPSPS to the bacteria cells facilitates growth even when supplemented with a high 20 mM dose of the well-known EPSPS inhibitor glyphosate (Rescue+Glyphosate 20 mM). However, supplementing with 20 mM of either one of compounds 1,2,3 and 4 (Rescue+20 mM compound 1-4) completely abolish the ability of AB2829 bacteria cells to grow on M9 minimal media.

FIG. 2: shows small molecule inhibitory effect on mutant EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (TIPS mutant) from common wheat (Triticum Aestivum) into E. coli bacterial line AB2829, using 0.1% rhamnose, rescues the growth phenotype (Rescue)(Set as 100% growth). Introducing the TIPS mutant of EPSPS to the bacteria cells facilitates growth even when supplemented with a high 20 mM dose of the well-known EPSPS inhibitor glyphosate (Rescue+Glyphosate 20 mM). However, supplementing with 20 mM of either one of compounds 5,6,7,8 and 9 (Rescue+20 mM compound 5-9) completely abolish the ability of AB2829 bacteria cells to grow on M9 minimal media.

FIG. 3: shows small molecule inhibitory effect on mutant EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (TIPS mutant) from common wheat (Triticum Aestivum) into E. coli bacterial line AB2829, using 0.1% rhamnose, rescues the growth phenotype (Rescue)(Set as 100% growth). Introducing the TIPS mutant of EPSPS to the bacteria cells facilitates growth even when supplemented with a high 20 mM dose of the well-known EPSPS inhibitor glyphosate (Rescue+Glyphosate 20 mM). However, supplementing with 20 mM of either one of compounds 10,11,12 and 13 (Rescue+20 mM compound 10-13) completely abolish the ability of AB2829 bacteria cells to grow on M9 minimal media.

FIG. 4: shows small molecule inhibitory effect on mutant EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (TIPS mutant) from common wheat (Triticum Aestivum) into E. coli bacterial line AB2829, using 0.1% rhamnose, rescues the growth phenotype (Rescue)(Set as 100% growth). Introducing the TIPS mutant of EPSPS to the bacteria cells facilitates growth even when supplemented with a high 20 mM dose of the well-known EPSPS inhibitor glyphosate (Rescue+Glyphosate 20 mM). However, supplementing with 20 mM of either one of compounds 14,15 and 16 (Rescue+20 mM compound 14-16) completely abolish the ability of AB2829 bacteria cells to grow on M9 minimal media.

FIG. 5: shows small molecule inhibitory effect on wild type EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (wild type) from common wheat (Triticum Aestivum) into E. coli bacterial line AB2829, using 0.1% rhamnose, rescues the growth phenotype (Rescue)(Set as 100% growth). However, introducing the wild type EPSPS to the bacteria cells could not facilitates growth when supplemented with a 0.7 mM dose of the well-known EPSPS inhibitor glyphosate (Rescue+Glyphosate 0.7 mM). In a similar manner, supplementing with 5 mM of either one of compounds 1,2,3 and 4 (Rescue+5 mM compound 1-4) completely abolish the ability of AB2829 bacteria cells to grow on M9 minimal media.

FIG. 6: shows small molecule inhibitory effect on wild type EPSP Synthase (EPSPS), presented as bacterial growth of E. coli line AB2829 as measured by optical density (OD600) 40 h post application of the molecules. The AB2829 line carries a null mutation in the aroA gene that encodes for EPSPS. When grown on M9 minimal media the bacteria are unable to grow (EPSPS null)(Set as 0% growth). Introducing EPSPS (wild type) from common wheat (Triticum Aestivum) into E. coli bacterial line AB2829, using 0.1% rhamnose, rescues the growth phenotype (Rescue)(Set as 100% growth). However, introducing the wild type EPSPS to the bacteria cells could not facilitates growth when supplemented with a 1.5 mM dose of the well-known EPSPS inhibitor glyphosate (Rescue+Glyphosate 1.5 mM). In a similar manner, supplementing with 5 mM of either one of compounds 10,11,12 and 13 (Rescue+5 mM compound 10-13) completely abolish the ability of AB2829 bacteria cells to grow on M9 minimal media.

FIG. 7: shows the ability of mutant EPSP Synthase (EPSPS), expressed in bacterial cells at gradually increasing concentrations, to resist the inhibitory effect of glyphosate applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A high 16.6 mM dose of the EPSPS inhibitor glyphosate combined with gradually increasing doses of rhamnose (0%-0.4%) facilitates growth in a gradual manner that correspond to the titration in EPSPS TIPS intracellular levels (Rhamnose+16.66 mM Glyphosate)(shaped lines).

FIG. 8: shows the ability of mutant EPSP Synthase (EPSPS), expressed in bacterial cells at gradually increasing concentrations, to resist the inhibitory effect of compound 3 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 2.5 mM dose of compound 3 combined with gradually increasing doses of rhamnose (0%-0.4%) facilitates growth in a gradual manner that correspond to the titration in EPSPS TIPS intracellular levels (Rhamnose+2.5 mM compound 3)(shaped lines).

FIG. 9: shows the ability of mutant EPSP Synthase (EPSPS), expressed in bacterial cells at gradually increasing concentrations, to resist the inhibitory effect of compound 4 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4 rhamnose, rescues the growth phenotype (rescue, thin solid line). A 1.0 mM dose of compound 4 combined with gradually increasing doses of rhamnose (0%-0.4%) facilitates growth in a gradual manner that correspond to the titration in EPSPS TIPS intracellular levels (Rhamnose+1.0 mM compound 4)(shaped lines).

FIG. 10: shows the ability of mutant EPSP Synthase (EPSPS), expressed in bacterial cells at gradually increasing concentrations, to resist the inhibitory effect of compound 9 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 1.0 mM dose of compound 9 combined with gradually increasing doses of rhamnose (0%-0.4%) facilitates growth in a gradual manner that correspond to the titration in EPSPS TIPS intracellular levels (Rhamnose+1.0 mM compound 9)(shaped lines).

FIG. 11: shows the ability of mutant EPSP Synthase (EPSPS), expressed in bacterial cells at gradually increasing concentrations, to resist the inhibitory effect of compound 10 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 0.4 mM dose of compound 10 combined with gradually increasing doses of rhamnose (0%-0.4%) facilitates growth in a gradual manner that correspond to the titration in EPSPS TIPS intracellular levels (Rhamnose+0.4 mM compound 10)(shaped lines).

FIG. 12: shows the ability of mutant EPSP Synthase (EPSPS), expressed in bacterial cells at gradually increasing concentrations, to resist the inhibitory effect of compound 11 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 0.5 mM dose of compound 11 combined with gradually increasing doses of rhamnose (0%-0.4%) facilitates growth in a gradual manner that correspond to the titration in EPSPS TIPS intracellular levels (Rhamnose+0.5 mM compound 11)(shaped lines).

FIG. 13: shows the ability of mutant EPSP Synthase (EPSPS), expressed in bacterial cells at gradually increasing concentrations, to resist the inhibitory effect of compound 13 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 0.25 mM dose of compound 13 combined with gradually increasing doses of rhamnose (0%-0.4%) could not facilitates growth in a gradual manner that correspond to the titration in EPSPS TIPS intracellular levels (Rhamnose+0.25 mM compound 13)(shaped lines).

FIG. 14: shows the ability of mutant EPSP Synthase (EPSPS), expressed in bacterial cells at gradually increasing concentrations, to resist the inhibitory effect of compound 10 applied to the cell at a single, otherwise inhibitory, dose. The level of resistance that mutant EPSP Synthase (EPSPS) confers to the cell is presented as continuous bacterial growth of E. coli line AB2829 as measured by optical density (OD600) for 60 h post application of the molecules. The AB2829 line carries a null mutation in the aroA gene that encodes for EPSPS. When grown on M9 minimal media the EPSPS null bacteria are unable to grow (no treatment, thick solid line). Inducing the levels of EPSPS (TIPS mutant) from common wheat (Triticum Aestivum) in AB2829 bacteria, using 0.4% rhamnose, rescues the growth phenotype (rescue, thin solid line). A 0.6 mM dose of compound 15 combined with gradually increasing doses of rhamnose (0%-0.4%) facilitates growth in a gradual manner that correspond to the titration in EPSPS TIPS intracellular levels (Rhamnose+0.6 mM compound 15)(shaped lines).

FIG. 15: show an In-vitro kinetics of EPSPS enzymatic activity in presence of glyphosate. Analysis of Michaelis-Menten kinetics without inhibitor or in the presence of 0.08 μM-5.25 μM of glyphosate for WT EPSPS (A, Upper panel) and 160 μM-10250 μM of glyphosate for TIPS mutant (A, Lower panel) determined Ki values of 458 nM and 459,123 nM, respectively. Extraction of IC50 values also indicate that glyphosate's inhibition of WT EPSPS activity is 3 orders of magnitude stronger than its ability to inhibit EPSPS in the presence of the TIPS mutation. Analysis of Michaelis-Menten and Lineweaver-Burk plots clearly validates that glyphosate is a competitive inhibitor of EPSPS by showing that increased glyphosate concentrations result in increased PEP's Km (apparent Km) (B) without effecting the Vmax of the reaction (C).

FIG. 16: show an In-vitro kinetics of EPSPS enzymatic activity in presence of compound 4. The experiments indicates that compound 4 is a competitive inhibitor of EPSPS. Analysis of Michaelis-Menten kinetics without inhibitor or in the presence of 25 μM-1640 μM of compound 4 for WT EPSPS (A, Upper panel) and 50 μM-3280 μM of compound 4 for TIPS mutant (A, Lower panel) determined Ki values of 44,035 nM and 57,382 nM, respectively. Extraction of IC50 values also indicate that compound 4 ability to inhibit WT EPSPS activity is hardly affected by the presence of the TIPS mutation. Analysis of both Michaelis-Menten and Lineweaver-Burk plots clearly validates the computationally suggested mechanism of action of the shikimate analog, according to which compound 4 is a competitive inhibitor of EPSPS that binds to the shikimate binding site in the enzyme. This is indicated by the increase in S3P's Km (apparent Km) (B), which is correlated to the increase in compound 4 concentrations, together with the lack of effect observed on the Vmax of the reaction (C). All together this evaluation demonstrates that compound 4 is a competitive inhibitor of EPAPS.

FIG. 17: Compound 4 is superior to glyphosate in the presence of the TIPS mutation. Direct comparison of glyphosate vs. compound 4 inhibition of WT and TIPS EPSPS demonstrate that relative to glyphosate (IC₅₀ WT=2.8 μM vs. IC₅₀ TIPS=4381 μM), compound 4 is one order of magnitude better then glyphosate in inhibiting the TIPS mutant, since it is indifferent to the presence of TIPS mutation (IC₅₀ WT=262 μM vs. IC₅₀ TIPS=576 μM). This indifference exhibited by compound 4 to the TIPS mutation relative to WT, is expected and consistent with the validated mechanism of action—competitive inhibitor of S3P.

FIG. 18: Shows the inhibitory effect of Glyphosate and compound 4 on mutant EPSP Synthase (TIPS EPSPS), presented as inhibition of bacterial growth of E. coli line AB2829. The AB2829 line carries a null mutation in the aroA gene that encodes for EPSPS. We have stably transformed this line with a vector expressing common wheat (Triticum Aestivum) EPSPS under the control of a rhamnose inducible promoter. When grown on M9 minimal media without rhamnose the bacteria are unable to grow (No rescue) (set as 100% growth inhibition). However, inducing the expression of the TIPS mutant using 0.1% rhamnose rescues the growth phenotype (Rescue) enabling bacterial growth on M9 minimal media (set as 0% growth inhibition). Under the same rescue conditions, the inhibitory effect of four low glyphosate doses 0.1, 0.5, 1.0 and 2.5 mM and one higher 25.0 mM dose, which is close to glyphosate's IC50, was tested (Glyphosate IC50 on TIPS mutant was determined to be ˜20-25 mM in this system at t=20-40 hours post rhamnose induction). In addition, the inhibitory effect of a single 2.5 mM dose of compound 4 was tested either individually vs. glyphosate (Upper panel) or in combination with all five glyphosate concentrations tested (Lower panel). Results from this experiment, quantified at t=15 h post rhamnose induction, indicate that combination of compound 4 with glyphosate yields an inhibitory effect on TIPS which is at least additive

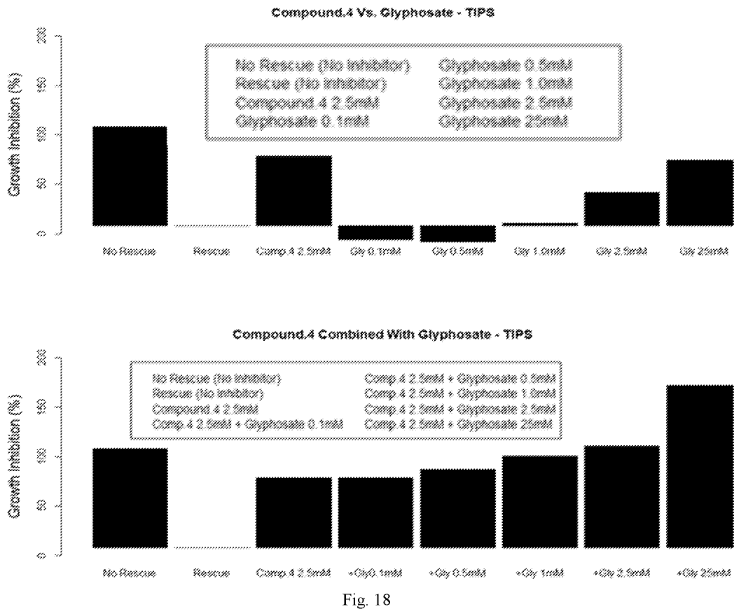

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

The subject invention provides a pesticidal composition comprising an agriculturally acceptable carrier and at least one compound of Formula (A)

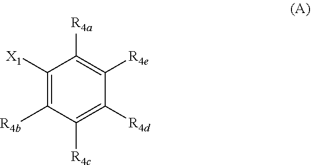

wherein
X₁ is H, alkyl of C₁-C₁₂, OR₁, COR₂, SR₁, NO₂, halogen, CH₂F, CHF₂, CF₃, N—(—R₃)₂, CN, SO₂R₂, or

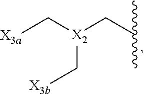

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or R₄ₑ forms a five-membered fused ring with R_{4d},
   or a salt thereof.

In some embodiments, the compound of Formula (A) is a compound of Formula (I)

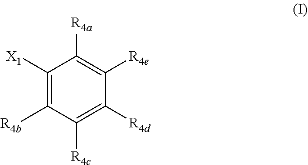

wherein
X₁ is H, alkyl C₁-C₁₂, OR₁, COR₂, SR₁, NO₂, halogen, CH₂F, CHF₂, CF₃, N—(—R₃)₂, CN, SO₂R₂, or

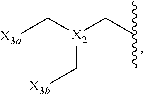

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂ alkynyl of C₁-C₁₀,
X₂ is CH or N, and
each of X₃ₐ and X_{3b} is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
      R₈ is H, alkyl, alkenyl, alkynyl of C₁-C₃, SO₂—R₆, CO₂-alkyl, CO₂-alkenyl, or CO₂-alkynyl of C₁-C₃,
or a salt thereof.

In some embodiments, the compound of Formula (A) is a compound of Formula (II)

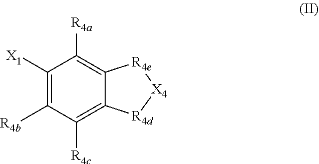

wherein
X₁ is H, alkyl C₁-C₁₂, OR₁, COR₂, SR₁, NO₂, halogen, CH₂F, CHF₂, CF₃, N—(—R₃)₂, CN, SO₂R₂ or

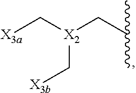

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
each of R₄ₐ, R_{4b} and R_{4c} is, independently, H, alkyl, alkenyl, alkynyl of C₁-C₃, OR₅, COR₆, SR₅, NO₂, halogen, CH₂F, CHF₂, CF₃, NR₇R₈, CN, or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
and
R₄ₑ forms a five-membered fused ring with R_{4d} and X₄,
   wherein
   each of R₄ₑ, R_{4d} and X₄ is, independently C(R₉)₂, C(O), NR₉, O, S, SO, or SO₂,
   wherein
   R₉ is H, OH, O-alkyl, O-alkenyl, O-alkynyl of C₁-C₃, alkyl, alkenyl, or alkynyl of C₁-C₃;
or a salt thereof.

The subject invention provides a pesticidal composition comprising an

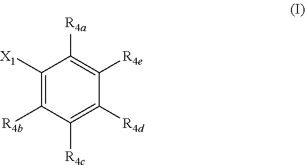

wherein
X₁ is H, alkyl C₁-C₁₂, OR₁, COR₂, SR₁, NO₂, halogen, CH₂F, CHF₂, CF₃, N—(—R₃)₂, CN, SO₂R₂, or

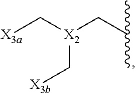

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂ alkynyl of C₁-C₁₀,
X₂ is CH or N, and
each of X₃a and X₃b is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or a salt thereof;
   or (ii) at least one compound of Formula (II)

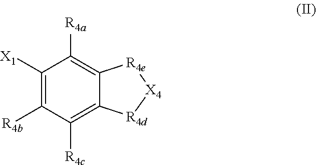

wherein
X₁ is H, alkyl C₁-C₂, OR₁, COR₂, SR₁, NO₂, halogen, CH₂F, CHF₂, CF₃, N—(—R₃)₂, CN, SO₂R₂ or

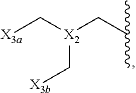

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
each of R₄ₐ, R_{4b} and R_{4c} is, independently, H, alkyl, alkenyl, alkynyl of C₁-C₃, OR₅, COR₆, SR₅, NO₂, halogen, CH₂F, CHF₂, CF₃, NR₇R₈, CN, or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
and
R₄ₑ forms a five-membered fused ring with R_{4d} and X₄,
   wherein
   each of R₄ₑ, R_{4d} and X₄ is, independently C(R₉)₂, C(O), NR₉, O, S, SO, or SO₂,
   wherein
   R₉ is H, OH, O-alkyl, O-alkenyl, O-alkynyl of C₁-C₃, alkyl, alkenyl, or alkynyl of C₁-C₃;
or a salt thereof.

In some embodiments, the pesticidal composition comprises at least one compound of Formula (I).

In some embodiments, the pesticidal composition comprises at least one compound of Formula (II).

In some embodiments, X₁ is H. In some embodiments, X₁ is OR₁. In some embodiments, X₁ is COR₂. In some embodiments, X₁ is NO₂.

In some embodiments, R₁ is H.

In some embodiments, R₂ is OH.

In some embodiments, X₁ is OH. In some embodiments, X₁ is COOH. In some embodiments, X₁ is NO₂.

In some embodiments, X₁ is

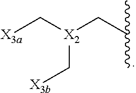

In some embodiments, X₂ is CH. In some embodiments, X₂ is N.

In some embodiments, X₃a is COOH. In some embodiments, X₃a is PO₃H₂. In some embodiments, X₃a is NO₂. In some embodiments, X₃b is COOH. In some embodiments, X₃b is PO₃H₂. In some embodiments, X₃b is NO₂.

In some embodiments, each of R₄ₐ, R_{4b}, R_{4c}, R_{4d} and R₄ₑ is, independently, H, OR₅, COR₆, NO₂, halogen, CF₃, or NR₇R₈.

In some embodiments, the halogen is F.

In some embodiments, R₅ is H. In some embodiments, R₅ is an alkyl. In some embodiments, R₅ is CH₃.

In some embodiments, R₆ is OH. In some embodiments, R₆ is O-alkyl. In some embodiments, R₆ is OCH₃.

In some embodiments, R₇ is H.

In some embodiments, R₈ is CH₃.

In some embodiments, R₄ₐ is H. In some embodiments, R₄ₐ is OH. In some embodiments, R₄ₐ is OCH₃. In some embodiments, R₄ₐ is NH₂. In some embodiments, R₄ₐ is NHCH₃. In some embodiments, R₄ₐ is NO₂. In some embodiments, R₄ₐ is F.

In some embodiments, R_{4b} is H. In some embodiments, R_{4b} is OH. In some embodiments, R_{4b} is OCH₃. In some embodiments, R_{4b} is NO₂. In some embodiments, R_{4b} is F.

In some embodiments, R₄ₑ is H. In some embodiments, R₄ₑ is COOH. In some embodiments, R_{4c} is NO₂.

In some embodiments, R_{4d} is H.

In some embodiments, R₄ₑ is COOH. In some embodiments, R₄ₑ is COOCH₃. In some embodiments, R₄ₑ is OCH₃. In some embodiments, R₄ₑ is CF₃.

In some embodiments, the compound is a compound of Formula (II) and R₄ₑ forms a five-membered fused ring with R_{4d} and X₄.

In some embodiments, the compound is a compound of Formula (II) and R₄ₑ is C(O).

In some embodiments, the compound is a compound of Formula (II) and X₄ is NR₉.

In some embodiments, R₉ is H. In some embodiments, R₉ is C₁-C₆ alkyl.

In some embodiments, the compound is a compound of Formula (II) and R_{4d} is C(O).

In some embodiments, the compound is a compound of Formula (II) and R₄ₑ, R₄ₐ and X₄ join to form a fused five-membered fused ring, the ring that is formed having the structure

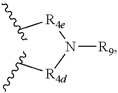

wherein each of R₄ₑ and R_{4d} is a carbonyl, X₄ is NR₉, and R₉ is H or C₁-C₆ alkyl.

In some embodiments, wherein
X₁ is OR₁ or COR₂,
   wherein
   R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
   R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃.

In some embodiments, wherein
X₁ is OR₁ or COR₂,
   wherein
   R₁ is H or C₁-C₁₀ alkyl,
   R₂ is OH or O-alkyl.

In some embodiments, wherein
each of R₄ₐ, R_{4b}, R_{4c}, R_{4d} and R₄ₑ is, independently, H, OR₅, COR₆, NO₂, halogen, CH₂F, CHF₂, CF₃, NR₇R₈, CN or SO₂R₆,
   wherein R₅, R₇ and R₈ are each H.

In some embodiments, wherein
each of R₄ₐ, R_{4b}, R_{4c}, R_{4d} and R₄ₑ is, independently, H, OR₅, NO₂, halogen, or NR₇R₈,
   wherein R₅, R₇ and R₈ are each H.

In some embodiments, wherein one of X₁, R₄ₐ, R_{4b}, R_{4c}, R_{4d} and R₄ₑ is other than H.

In some embodiments, wherein two of X₁, R₄ₐ, R_{4b}, R_{4c}, R_{4d} and R₄ₑ are other than H.

In some embodiments, wherein three of X₁, R₄ₐ, R_{4b}, R_{4c}, R_{4d} and R₄ₑ are other than H.

In some embodiments, wherein four of X₁, R₄ₐ, R_{4b}, R_{4c}, R_{4d} and R₄ₑ are other than H.

In some embodiments, wherein at least one of X₁, R₄ₐ, R_{4b}, R_{4c}, R_{4d} and R₄ₑ is NO₂.

In some embodiments, wherein at least two of X₁, R₄ₐ, R_{4b}, R_{4c}, R_{4d} and R₄ₑ are NO₂.

In some embodiments, the compound of Formula (I) has the structure:

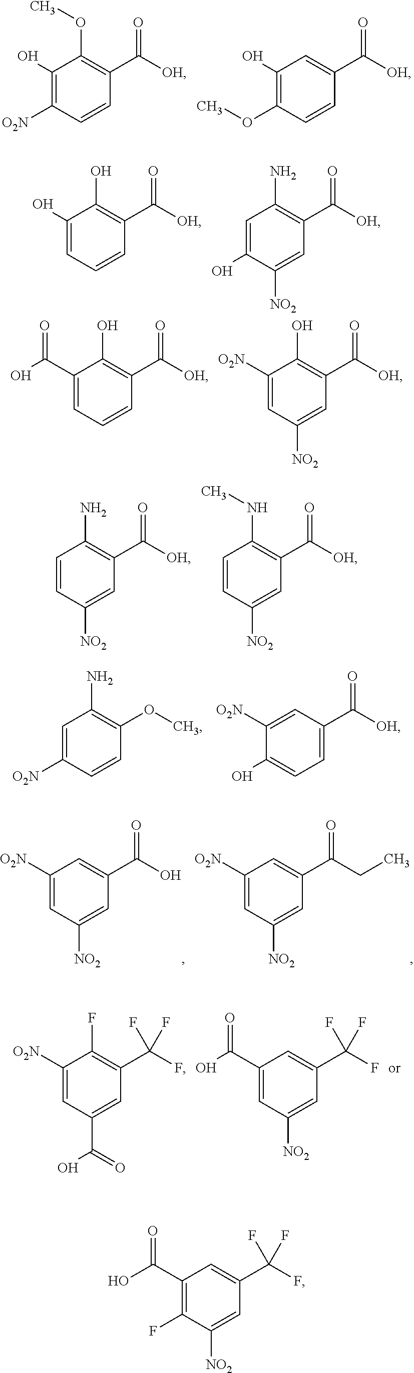

or a salt thereof.

In some embodiments, the compound of Formula (II) has the structure:

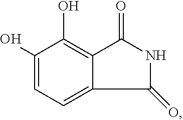 [SMILES: O=C1NC(=O)c2c1ccc(O)c2O]

or a salt thereof.

In some embodiments, the concentration of the compound(s) of Formula (A) in the composition is about 0.1-99 wt. %, about 0.1-95 wt. %, or about 0.1-90 wt. %, based on the total weight of the composition. In another embodiment, the concentration of the compound(s) of Formula (A) in the composition is about 1-70 wt. %, based on the total weight of the composition. In yet another embodiment, the concentration of the compound(s) of Formula (A) in the composition is about 1-99 wt. %, based on the total weight of the composition. In yet another embodiment, the concentration of the compound(s) of Formula (A) in the composition is about 1-40 wt. %, based on the total weight of the composition. In yet another embodiment, the concentration of the compound(s) of Formula (A) in the composition is about 1-30 wt. %, based on the total weight of the composition. In yet another embodiment, the concentration of the compound(s) of Formula (A) in the composition is about 1-20 wt. %, based on the total weight of the composition. In yet another embodiment, the concentration of the compound(s) of Formula (A) in the composition is about 1-10 wt. %, based on the total weight of the composition. In yet another embodiment, the concentration of the compound(s) of Formula (A) in the composition is about 0.1%, 0.5%, 1%, 1.5%, 2%, 2.5%, 3%, 3.5%, 4%, 4.5%, 5% to about 90%, 93%, 95%, 98%, 99% based on the total weight of the composition.

In some embodiments, the pesticidal composition is a herbicidal composition.

In some embodiments, the pesticidal composition is a bactericidal composition.

In some embodiments, the pesticidal composition is a fungicidal composition.

In some embodiments, the pesticidal composition further comprises at least one agriculturally acceptable carrier. In some embodiments, the pesticidal composition further comprises at least one additive.

In some embodiments, the pesticidal composition is a pesticidal composition.

In some embodiments, the pesticidal composition is a herbicidal composition.

In some embodiments, the pesticidal composition is a bactericidal composition.

In some embodiments, the pesticidal composition is a fungicidal composition.

In some embodiments, the pesticidal composition further comprises at least one agriculturally acceptable carrier. In some embodiments, the pesticidal composition further comprises at least one additive.

In some embodiments, the pesticidal composition further comprising glyphosate.

The present composition may be employed or prepared in any conventional form, for example, in the form of a twin pack, or for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, solvent or oil, which are suitable for dilution with water.

The compounds of Formula (A) may be used in the preparation of agricultural compositions such as pesticides, antibiotics or any other medical usage consisting of EPSPS modulation. These compounds may also be used for research purposes.

The compounds of Formula (I) or Formula (II) may be used in the preparation of agricultural compositions such as pesticides, antibiotics or any other medical usage consisting of EPSPS modulation. These compounds may also be used for research purposes.

Any compound of Formula (A) may be considered a candidate for an EPSPS binding molecule for both wild type and mutant resistant types. It is noted that the specific combinations may be selected with respect to delivery considerations of the molecule to the target, e.g., with respect to the molecule solubility and biological interactions that may be determined experimentally along the lines exemplified herein for specific molecule examples.

Any compound of Formula (I) or Formula (II) may be considered a candidate for an EPSPS binding molecule for both wild type and mutant resistant types. It is noted that the specific combinations may be selected with respect to delivery considerations of the molecule to the target, e.g., with respect to the molecule solubility and biological interactions that may be determined experimentally along the lines exemplified herein for specific molecule examples.

The compounds of Formula (A) and their derivatives may be used in the agricultural industry as pesticides such as broad action herbicides and may be applied in a wide variety of settings.

The compounds of Formula (I) or Formula (II) and their derivatives may be used in the agricultural industry as pesticides such as broad action herbicides and may be applied in a wide variety of settings.

The present invention also provides a method for the control or prevention of pest, comprising applying a pesticidally effective amount any one of the pesticidal compositions disclosed herein to the pest, a locus of the pest and/or an area in which pest infestation is to be prevented so as to thereby control or prevent pest.

The present invention also provides a method for the control or prevention of pest in a crop field, comprising applying a pesticidally effective amount any one of the pesticidal compositions disclosed herein to the pest, a locus of the pest and/or an area in which pest infestation is to be prevented so as to thereby control or prevent pest in the crop field.

In some embodiments, the pest is unwanted vegetation.

In some embodiments, the pest is bacteria.

In some embodiments, the pest is fungi.

The pesticidally effective application rates of the pesticidal composition cannot generally be defined, as it varies depending upon various conditions such as the type of the formulation, weather conditions, the type of crop and the type of pest.

In an embodiment, the pesticidal composition may be applied in an amount from about 0.05 g/ha to 5000 g/ha, preferably from about Ig/ha to 500 g/ha, even more preferably from 50 g/ha to 100 g/ha. In a further embodiment, the pesticidal composition may be applied in an amount from about 1000 to 4000 g/ha. In yet another embodiment, the pesticidal composition may be applied in an amount from about 1000 to 3000 g/ha. In yet another embodiment, the pesticidal composition may be applied in an amount from about 1000 g/ha to 2500 g/ha. In yet another embodiment, the pesticidal composition may be applied in an amount from about 1000 g/ha to 2000 g/ha. In yet another embodiment, the pesticidal composition may be applied in an amount from about 1000 g/ha to 1500 g/ha. In yet another embodiment, the pesticidal composition may be applied in an amount from about 1000 g/ha to 1250 g/ha. The above application rates refer to the amount of the compound(s) of Formula (A) in pesticidal composition. The above application rates refer to the amount of the compound(s) of Formula (A) in the pesticidal composition. The above application rates refer to the amount of the compound(s) of Formula (I) or Formula (II) in the pesticidal composition.

The pesticidal compositions may be applied to the pest or may be applied to the locus of the pest. The pesticidal compositions may also be applied to an area in which pest infestation is to be prevented.

Further, the pesticidal composition may be applied pre-plant incorporated, pre-emergence, post-emergence. In some embodiments, the pesticidal composition is applied early-post-emergence.

The pesticidal composition may be applied via foliar application, broadcast, basal application, soil application, soil incorporation or soil injection.

In an embodiment, the unwanted vegetation is weed. In an embodiment, the weed is glyphosate-resistant or glyphosate-tolerant weed. The weeds can be controlled or prevented in fields of various crops.

The crop may include but is not limited to grain crops such as barley, buckwheat, millet, oats, rice, rye, quinoa, sugar beet, teff, teosinte, triticale, wheat (all types), wild rice but also corn such as filed corn, seed corn, silage corn, sweet corn and popcorn as well as soybean, cotton and oilseed crops such as borage, buffalo gourd, canola, crambe, flax, jojoba, lesquerella, meadowforam, mustard, oilseed rape, safflower, sesame, sunflower and also grain sorghum (milo), soybean, sugar cane aloe vera, Asparagus, Bamboo shoots, Globe artichoke, Okra, Peanut (ground nut), Pineapple, Strawberry, Sugar and cotton as well as tree, vines and shrub crops The crop may also include herbs and spices such as Allspice, Angelica, Star anise, Annatto (seed), Balm, Basil, Borage, Burnet, Camomile, Caper buds, Caraway, Black caraway, Cardamom, Cassia bark, Cassia buds, Catnip, celery seed, Chervil (dried), Chive, Chinese chive, Cinnamon, Clary, Clove buds, Coriander leaf (cilantro or chinese parsley), Coriander seed (cilantro), Costmary, Culantro (leaf), Culantro (seed), Cumin, Curry (leaf), Dill (dillweed), Dill (seed), Epazote, Fennel seed (common and Florence), Fenugreek, White ginger flower, Grains of paradise, Horehound, Hyssop, Juniper berry, Lavender, Lemongrass, Lovage (leaf and seed), Mace, Marigold, Marjoram (including oregano), Mexican oregano, Mioga flower, Mustard (seed), Nasturtium, Nutmeg, Parsley (dried), Pennyroyal, Pepper (black and white), Pepper leaves, Peppermint, Perilla, Poppy (seed), Rosemary, Rue, Saffron, Sage, Savory (summer and winter), Spearmint, Stevia leaves, Sweet bay, Tansy, Tarragon, Thyme, Vanilla, Wintergreen, Woodruff, Wormwood. The crops may also be vegetable crops such as brassica vegetables (Broccoli, Chinese broccoli (gailon), Broccoli raab (rapini), Brussels sprouts, Cabbage, Chinese cabbage (bok choy), Chinese cabbage (napa), Chinese mustard cabbage (gai choy), Cauliflower, Cavalo broccolo, Collards, Kale, Kohlrabi, Mizuna, Mustard greens, Mustard spinach, Rape greens), bulb vegetables (Garlic, Great-headed garlic, Leek, Onion (dry bulb and green), Welsh Onion, Shallo), cucurbit vegetables and fruits (Chayote (fruit), Chinese waxgourd (Chinese preserving melon), Citron melon, Cucumber, Gherkin, Edible gourd (includes hyotan, cucuzza, hechima, Chinese okra), Melons (all), Momordica spp (includes balsam apple, balsam pear, bittermelon, Chinese cucumber), Muskmelon (includes cantaloupe, casaba, crenshaw melon, golden pershaw melon, honeydew melon, honey ball melon, mango melon, Persian melon, pineapple melon, Santa Claus melon, snake melon), Pumpkin, Summer squash (includes crookneck squash, scallop squash, straightneck squash, vegetable marrow, zucchini), Winter squash (includes butternut squash, calabaza, hubbard squash, acorn squash, spaghetti squash), Watermelon.), leafy vegetables (Amaranth (Chinese spinach), Arugula (roquette), Beet greens, Cardoon, Celery, Chinese celery, Celtuce, Chaya, Chervil, Edible-leaved chrysanthemum, Garland chrysanthemum, Corn salad, Cress (garden and upland), Dandelion, Dock (sorrel), Dokudami, Endive (escarole), Florence fennel, Gow kee, Lettuce (head and leaf), Orach, Parsley, Purslane (garden and winter), Radicchio (red chicory), Rhubarb, Spinach, New Zealand spinach, Vine spinach, Swiss chard, Watercress (upland), Water spinach.), fruiting vegetables (Eggplant, Groundcherry (Physalis spp), Pepino, Pepper (includes bell pepper, chili pepper, cooking pepper, pimento, sweet pepper), Tomatillo, Tomato), legume vegetables (Bean (Lupinus: includes grain lupin, sweet lupin, white lupin, and white sweet lupin), Bean (Phaseolus: includes field bean, kidney bean, lima bean, navy bean, pinto bean, runner bean, snap bean, tepary bean, wax bean), Bean (Vigna: includes adzuki bean, asparagus bean, blackeyed pea, catjang, Chinese longbean, cowpea, crowder pea, moth bean, mung bean, rice bean, southern pea, urd bean, yardlong bean), Broad bean (fava), Chickpea (garbanzo), Guar, Jackbean, Lablab bean, Lentil, Pea (Pisum: includes dwarf pea, edible-podded pea, English pea, field pea, garden pea, green pea, snowpea, sugar snap pea), Pigeon pea, Soybean (immature seed), Sword bean.), root and tuber vegetables (Arracacha, Arrowroot, Chinese artichoke, Jerusalem artichoke, Beet (garden), Burdock, Canna, Carrot, Cassava (bitter and sweet), Celeriac, Chayote (root), Chervil (turnip-rooted), Chicory, Chufa, Dasheen (taro), Galangal, Ginger, Ginseng, Horseradish, Leren, Kava (turnip-rooted), Parsley (turnip-rooted), Parsnip, Potato, Radish, Oriental radish, Rutabaga, Salsify, Black salsify, Spanish salsify, Skirret, Sweet potato, Tanier, Turmeric, Turnip, Wasabi, Yacon, Yam bean, True yam.). In some embodiments, the crop is wheat (all type). In some embodiment, the wheat is Triticum Aestivum. In some embodiments, the crop is corn, wheat, soybean, rice, cotton, oilseed rape, barley or sugar beet. In some embodiments, the crop is glyphosate resistant.

In yet another embodiment, the unwanted vegetation may be monocotyledonous or dicotyledonous weeds which may include one or more of Alopecurus myosuroides, Amaranthus retroflexus, Anthemis arvensis, Apera spica-venti, Capsella bursa-pastoris, Centaurea cyanus, Chenopodium album, Descurainia sophia, Erodium cicutarium, Fumaria officinalis, Galium aparine, Geranium dissectum, Germanium pusillum, Geranium rotundifolium, Geranium spp., Hordeum vulgare, Lamium amplexicaule, Lamium purpureum, Lolium multiflorum, Lolium perenne, Matricaria chamomilla, Matricaria inodora, Matricaria recutita, Myosotis arvensis, Papaver rhoeas, Polygonum convolvulus, Raphanus raphanistrum, Senecio vulgaris, Sinapis alba, Sinapis arvensis, Sisymbrium officinale, Sonchus arvensis, Stellaria media, Thlaspi arvense, Triticum aestivum, Triticum durum, Veronica hederaefolia, Veronica persica, Veronica spp., and Viola arvensis but also Amaranthus hybridus, Amaranthus palmeri, Amaranthus spinosus, Amaranthus tuberculatus, Ambrosia artemisiifolia, Ambrosia trifida, Bidens pilosa, Brachiaria eruciformis, Brassica rapa, Bromus diandrus, Bromus rubens, Chloris elata, Chloris truncata, Chloris virgata, Conyza bonariensis, Conyza Canadensis, Conyza sumatrensis, Cynodon hirsutus, Digitaria insularis, Echinochloa colona, Eleusine indica, Hedyotis verticillata, Helianthus annuus, Hordeum murinum ssp. Glaucum, Kochia scoparia, Lactuca saligna, Lactuca serriola, Leptochloa virgate, Lolium perenne, Lolium perenne ssp. multiflorum, Lolium rigidum, Parthenium hysterophorus, Paspalum paniculatum, Plantago lanceolata, Poa annua, Raphanus raphanistrum, Salsola tragus, Sonchus oleraceus, Sorghum halepense, Tridax procumbens, Unrochloa panicoides as well as Cyperus spp., Cyperaceae family or any other plant. In some embodiments, the weed is Lolium multiflorum. In some embodiments, the weed is Chenopodium album.

In an embodiment, the compound(s) of Formula (A) or salts thereof may be applied with at least one additional pesticide.

In an embodiment, the compound(s) of Formula (I) or salts thereof may be applied with at least one additional pesticide.

In an embodiment, the compound(s) of Formula (II) or salts thereof may be applied with at least one additional pesticide.

In an embodiment, the pesticidal composition (s) disclosed herein may be applied with at least one additional pesticide.

In an embodiment, the compound(s) of Formula (A) or salts thereof may be formulated with the additional pesticide(s), tank mixed with the additional pesticide(s) or applied sequentially with the additional pesticide(s).

In an embodiment, the compound(s) of Formula (I) or salts thereof may be formulated with the additional pesticide(s), tank mixed with the additional pesticide(s) or applied sequentially with the additional pesticide(s).

In an embodiment, the compound(s) of Formula (II) or salts thereof may be formulated with the additional pesticide(s), tank mixed with the additional pesticide(s) or applied sequentially with the additional pesticide(s).

In an embodiment, the pesticidal composition(s) disclosed herein may be formulated with the additional pesticide(s), tank mixed with the additional pesticide(s) or applied sequentially with the additional pesticide(s).

In some embodiments, the additional pesticide is a herbicide, a fungicide, a bactericide, an insecticide, a biostimulant or a safener.

The additional pesticide may include but are not limited to 4-CPA; 4-CPB; 4-CPP; 2,4-D; 2,4-D choline salt, 2,4-D esters and amines, 2,4-DB; 3,4-DA; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butenachlor, buthidazole, buthiuron, butroxydim, buturon, butylate, cacodylic acid, cafenstrole, calcium chlorate, calcium cyanamide, cambendichlor, carbasulam, carboxazole chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimexano, dimidazon, dinofenate, dinoprop, dinosam, dinoseb, dinoterb, diphenamid, dipropetryn, diquat, disuldiuron, DMPA, DNOC, DSMA, EBEP, eglinazine, endothal, epronaz, EPTC, erbon, esprocarb, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, ferrous sulfate, flamprop, flamprop-M, flazasulfuron, florasulam, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, fluoroxypyr-meptyl, flurtamone, fluthiacet, fomesafen, foramsulfuron, fosamine, fumiclorac, furyloxyfen, glufosinate, glufosinate salts and esters, glufosinate-ammonium, glufosinate-P-ammonium, glyphosate, glyphosate salts and esters, halauxifen, halauxifen-methyl, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazosulfuron, imazethapyr, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oxadiargyl, oxadiazon, oxapyrazon, oxasulfuron, oxaziclomefone, oxyfluorfen, paraflufen-ethyl, parafluoron, paraquat, pebulate, pelargonic acidpenoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propisochlor, propoxycarbazone, propyrisulfuron, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluoron, thiazafluoronthidiazimin, thidiazuron, thiencarbazone-methyl, thifensulfuron, thifensulfurn-methyl, thiobencarb, tiocarbazil, tioclorim, topramezone, tralkoxydim, triafamone, tri-allate, triasulfuron, triaziflam, tribenuron, tribenuron-methyl, tricamba, triclopyr choline salt, triclopyr esters and salts, tridiphane, trietazine, trifloxysulfuron, trifluralin, triflusulfuron, trifop, trifopsime, trihydroxytriazine, trimeturon, tripropindan, tritac tritosulfuron, vernolate, xylachlor and salts, esters, optically active isomers and compositions thereof.

In some embodiments, the application of the compound(s) of Formula (A) with the additional pesticide(s) exhibit synergistic effects.

In some embodiments, the application of the compound(s) of Formula (I) with the additional pesticide(s) exhibit synergistic effects.

In some embodiments, the application of the compound(s) of Formula (II) with the additional pesticide(s) exhibit synergistic effects.

The present invention also provides a method for the control or prevention of pest, comprising applying a pesticidally effective amount of at least one compound of Formula (A) or a salt thereof as described herein to the pest, a locus of the pest and/or an area in which pest infestation is to be prevented so as to thereby control or prevent pest.

The present invention also provides a method for the control or prevention of pest, comprising applying a pesticidally effective amount of (i) at least one compound of Formula (I) or a salt thereof as described herein or (ii) at least one compound of Formula (II) or a salt thereof as described herein to the pest, a locus of the pest and/or an area in which pest infestation is to be prevented so as to thereby control or prevent pest.

The present invention also provides a method for the control or prevention of pest in a crop field, comprising applying a pesticidally effective amount of at least one compound of Formula (A) or a salt thereof as described herein to the pest, a locus of the pest and/or an area in which pest infestation is to be prevented so as to thereby control or prevent pest in the crop field.

The present invention also provides a method for the control or prevention of pest in a crop field, comprising applying a pesticidally effective amount of (i) at least one compound of Formula (I) or a salt thereof as described herein or (ii) at least one compound of Formula (II) or a salt thereof as described herein to the pest, a locus of the pest and/or an area in which pest infestation is to be prevented so as to thereby control or prevent pest in the crop field.

The present invention also provides a method of inhibiting 5-enolpyruvylshikimate-3-phosphate synthase (EPSPS) and/or its mutants by using at least one of the compounds of Formula (A) or a salt thereof as described herein.

The present invention also provides a method of inhibiting 5-enolpyruvylshikimate-3-phosphate synthase (EPSPS) and/or its mutants by using (i) at least one of the compounds of Formula (I) or a salt thereof as described herein or (ii) at least one of the compounds of Formula (II) or a salt thereof as described herein.

The present invention also provides a method of inhibiting shikimate kinase by using at least one of the compounds of Formula (A) or a salt thereof as described herein.

The present invention also provides a method of inhibiting shikimate kinase by using (i) at least one of the compounds of Formula (I) or a salt thereof as described herein, and/or (ii) at least one of the compounds of Formula (II) or a salt thereof as described herein.

A method for the control or prevention of pest in a crop field, comprising applying a pesticidally effective amount of at least one compound of Formula (A) or a salt thereof as defined in any one of claims 1-40 to the pest, a locus of the pest and/or an area in which pest infestation is to prevented so as to thereby control or prevent pest in the crop field.

The present invention also provides a method of inhibiting 5-enolpyruvylshikimate-3-phosphate synthase (EPSPS) comprising contacting the EPSPS with an effective amount of at least one compound of Formula (A) or a salt thereof, so as to thereby inhibit the EPSPS.

The present invention also provides a method of inhibiting shikimate kinase by sing comprising contacting the shikimate kinase with an effective amount of at least one compound of Formula (A) or a salt thereof, so as to thereby inhibit the shikimate kinase.

The present invention also provides a method for the control or prevention of pest in a crop field, comprising applying a pesticidally effective amount of at least one compound of Formula (A) or a salt thereof and glyphosate to the pest, the locus of the pest and/or the area in which pest infestation is to prevented, so as to thereby control or prevent pest in the crop field.

The present invention also provides a method of inhibiting 5-enolpyruvylshikimate-3-phosphate synthase (EPSPS) comprising contacting the EPSPS with an effective amount of at least one compound of Formula (A) or a salt thereof and glyphosate, so as to thereby inhibit the EPSPS.

The present invention also provides a method of inhibiting shikimate kinase comprising contacting the shikimate kinase with an effective amount of at least one compound of Formula (A) or a salt thereof and glyphosate, so as to thereby inhibit the shikimate kinase.

Mixture of Glyphosate and Compounds of Formula (A)

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein, the term “contemporaneous” when used in connection with application of agrochemicals means that an individual agrochemical is applied separately from another agrochemical or premixture at the same time or at times sufficiently close together that a synergistic activity or an activity that is additive or more than additive relative to the activity of either agrochemical alone at the same dose is achieved.

As used herein, the term “effective” when used in connection with an amount of the combination, mixture or composition refers to an amount of the combination, mixture or composition that achieve a good level of control of the pest when applied.

As used herein, the term “pesticidally effective amount” refers to an amount of the active component that is commercially recommended for use to control pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

The present invention provides a combination comprising (i) a amount of at least one compound of Formula (A)

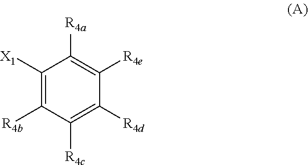

wherein
X₁ is H, alkyl of C₁-C₂, OR₁, COR₂, SR₁, NO₂, halogen, CH₂F, CHF₂, CF₃, N—(—R₃)₂, CN, SO₂R₂, or

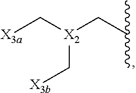

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or R₄ₑ forms a five-membered fused ring with R_{4d},
   or a salt thereof and (ii) an amount of glyphosate.

In some embodiments, the combination is more effective for controlling or preventing pest in a crop field than when each compound at the same amount is applied alone.

In some embodiments, the combination is more effective for inhibiting 5-enolpyruvylshikimate-3-phosphate synthase (EPSPS) than when each compound at the same amount is applied alone.

In some embodiments, the combination is more effective for inhibiting shikimate kinase than when each compound at the same amount is applied alone.

In some embodiments, the amount of the compound of Formula (A) and the amount of glyphosate is more effective for controlling or preventing pest in a crop field than when each compound at the same amount is applied alone.

In some embodiments, the amount of the compound of Formula (A) and the amount of glyphosate is more effective for inhibiting 5-enolpyruvylshikimate-3-phosphate synthase (EPSPS) than when each compound at the same amount is applied alone.

In some embodiments, the amount of the compound of Formula (A) and the amount of glyphosate is more effective for inhibiting shikimate kinase than when each compound at the same amount is applied alone.

In some embodiments, the amount of the compound of Formula (A) in the combination is less than the pesticidally effective amount of the compound of Formula (A) when the compound of Formula (A) is used alone.

In some embodiments, the amount of glyphosate in the combination is less than the pesticidally effective amount of glyphosate when glyphosate is used alone.

In some embodiments, the combination is a mixture. In some embodiments, the mixture is a tank mix.

In some embodiments, the mixture is synergistic.

The present invention provides a synergistic mixture of (i) at least one compound of Formula (A)

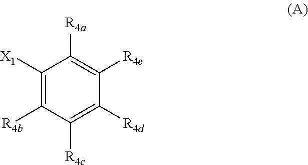

wherein
X₁ is H, alkyl of C₁-C₁₂, OR₁, COR₂, SR₁, NO₂, halogen, CH₂F, CHF₂, CF₃, N—(—R₃)₂, CN, SO₂R₂, or

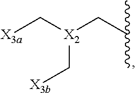

wherein
R₁ is H, alkyl, alkenyl, alkynyl of C₁-C₁₀, CO-alkyl, CO-alkenyl, CO-alkynyl of C₁-C₁₀, or CON—(—H, alkyl, alkenyl, or alkynyl of C₁-C₁₀)₂,
R₂ is OH, alkyl, alkenyl, alkynyl of C₁-C₁₀, O-alkyl, O-alkenyl, O-alkynyl of C₁-C₁₀, or N—(—H, alkyl, alkenyl, or alkynyl of C₁-C₁₀)₂,
R₃ is H, alkyl, alkenyl, alkynyl of C₁-C₁₀, SO₂—R₂, CO₂-alkyl, CO₂-alkenyl, or CO₂-alkynyl of C₁-C₁₀,
X₂ is CH or N, and
each of X₃a and X₃b is, independently, COOH, PO₃H₂ or NO₂;
and
each of R₄ₐ, R_{4b}, R_{4c}, R_{4d} and R₄ₑ is, independently, H, alkyl, alkenyl, alkynyl of C₁-C₃, OR₅, COR₆, SR₅, NO₂, halogen, CH₂F, CHF₂, CF₃, NR₇R₈, CN or SO₂R₆,
   wherein
   R₅ is H, alkyl, alkenyl, alkynyl of C₁-C₃, CO-alkyl, CO-alkenyl, CO-alkynyl of C₁-C₃, or CON—(—H, alkyl, alkenyl, or alkynyl of C₁-C₃)₂,
   R₆ is OH, alkyl, alkenyl, alkynyl of C₁-C₃, O-alkyl, O-alkenyl, O-alkynyl of C₁-C₃, or N—(—H, alkyl, alkenyl, or alkynyl of C₁-C₃)₂,
   R₇ is H, alkyl, alkenyl, alkynyl of C₁-C₃, SO₂—R₆, CO₂-alkyl, CO₂-alkenyl, or CO₂-alkynyl of C₁-C₃, and
   R₈ is H, alkyl, alkenyl, alkynyl of C₁-C₃, SO₂—R₆, CO₂-alkyl, CO₂-alkenyl, or CO₂-alkynyl of C₁-C₃,
or R₄ₑ forms a five-membered fused ring with R_{4d},
   or a salt thereof and (ii) glyphosate.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22. The expected effect for a given combination of two active components can be calculated as follows:

E=X+Y−XY/100

in which E represents the expected effect for the combination of the two active components and X and Y represents the effect of each active component alone. There is synergism when the observed effect is greater than the expected effect.

In the context of the subject invention, E represents the level of inhibition expected for the application of mixture of compound of Formula (A) at the defined doses of herbicide and glyphosate at the defined doses of herbicide. X is the level of inhibition for the application of glyphosate at the defined doses of herbicide. Y is the level of inhibition for compound of Formula (A) at the defined doses of herbicide. When the level of inhibition observed is greater than expected, there is a synergistic effect.

The present invention also provides a composition comprising any one of the combinations or mixtures disclosed herein.

The present invention also provides use of any one of the combinations, mixtures or compositions disclosed herein for controlling or preventing pest in a crop field.

The present invention also provides use of any one of the combinations, mixtures or compositions disclosed herein for inhibiting 5-enolpyruvylshikimate-3-phosphate synthase (EPSPS).

The present invention also provides use of any one of the combinations, mixtures or compositions disclosed herein for inhibiting shikimate kinase.

The present invention also provides a method of controlling or preventing pest in a crop field comprising applying an effective amount of any one of the combinations, mixtures, or compositions disclosed herein to the pest, the locus of the pest and/or the area in which pest infestation is to prevented, so as to thereby control or prevent pest in the crop field.

The present invention also provides a method of inhibiting 5-enolpyruvylshikimate-3-phosphate synthase (EPSPS) comprising contacting the EPSPS with an effective amount of any one of the combinations, mixtures, or compositions disclosed herein so as to thereby inhibit the EPSPS.

The present invention also provides a method of inhibiting shikimate kinase comprising contacting the shikimate kinase with an effective amount of any one of the combinations, mixtures, or compositions disclosed herein so as to thereby inhibit the shikimate kinase.

The present invention also provides a method of controlling or preventing pest in a crop field comprising applying an amount of the compound of Formula (A) as defined herein and an amount of glyphosate to the pest, the locus of the pest and/or the area in which pest infestation is to prevented, so as to thereby control or prevent pest in the crop field.

The present invention also provides a method of inhibiting 5-enolpyruvylshikimate-3-phosphate synthase (EPSPS) comprising contacting the EPSPS with an amount of the compound of Formula (A) as defined herein and an amount of glyphosate so as to thereby inhibit the EPSPS.

The present invention also provides a method of inhibiting shikimate kinase comprising contacting the shikimate kinase an amount of the compound of Formula (A) as defined herein and an amount of glyphosate so as to thereby inhibit the shikimate kinase.

In some embodiments, the amount of the compound of Formula (A) and the amount of glyphosate when applied together is more effective for controlling or preventing pest in a crop field than when compound at the same amount is applied alone.

In some embodiments, the amount of the compound of Formula (A) and the amount of glyphosate when applied together is more effective for inhibiting 5-enolpyruvylshikimate-3-phosphate synthase (EPSPS) than when compound at the same amount is applied alone.

In some embodiments, the amount of the compound of Formula (A) and the amount of glyphosate when applied together is more effective for shikimate kinase than when compound at the same amount is applied alone.

In some embodiments, the amount of the compound of Formula (A) applied is less than the pesticidally effective amount of the compound of Formula (A) when the compound of Formula (A) is used alone.

In some embodiments, the amount of glyphosate applied is less than the pesticidally effective amount of glyphosate than when glyphosate is used alone.

In some embodiments, the compound of Formula (A) and the glyphosate are applied simultaneously.

In some embodiments, the compound of Formula (A) and the glyphosate are applied contemporaneously.

The present invention also provides a package comprising any one of the combinations, mixtures or compositions disclosed herein.

In some embodiments, the package comprises instructions for using the combination, mixture or composition for controlling or preventing pest in a crop field, for inhibiting 5-enolpyruvylshikimate-3-phosphate synthase (EPSPS), and/or for inhibiting shikimate kinase. In some embodiments, the instructions comprise application rates, application times, target pest, and/or target plant as described herein.

The present invention also provides a process of preparing a combination, mixture or composition comprising (a) an amount of a compound of Formula (A) as described herein, and an amount of glyphosate, wherein the process comprises the steps of:

(i) obtaining the amount of the compound of Formula (A) and the amount of glyphosate, and

(ii) mixing the obtained amount of the compound of Formula (A) and the glyphosate to obtain the combination, mixture or composition.

In some embodiments, step (ii) is performed in a tank to obtain a tank mix.

In some embodiments, the process further comprises adding an agrochemically acceptable carrier to the combination, mixture or composition.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes 10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “0.1-99 wt. %” includes 0.1 wt. %, 0.2 wt. %, 0.3 wt. %, 0.4 wt. % etc. up to 99 wt. %.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Each embodiment disclosed herein is contemplated as being applicable to each of the other disclosed embodiments. Thus, all combinations of the various elements described herein are within the scope of the invention. In addition, the elements recited in composition embodiments can be used in the composition, methods and use embodiments described herein and vice versa.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

Examples are provided below to facilitate a more complete understanding of the present subject matter. The following examples illustrate the exemplary modes of making and practicing the present subject matter. However, the scope of the present subject matter is not limited to specific embodiments disclosed in these Examples, which are for purposes of illustration only. Other embodiments will be apparent to one skilled in the art from consideration of the specification and examples. It is intended that the specification, including the examples, is considered exemplary only without limiting the scope and spirit of the present subject matter.

### Experimental Details

Methods and Materials:

EPSPS expression and purification: His tagged WT and TIPS EPSPS from common wheat (Triticum Aestivum) were expressed in E. coli AB2829 bacteria (induction in 4 L LB using 0.1% rhamnose at 25° C. for 4 h) and purified using immobilized metal affinity chromatography (IMAC) (Ni Seph, 50 mM TrisHCl pH7.5+0.5M NaCl+10% Glycerol) followed by size exclusion chromatography (SEC)(Superose 12). Stock concentration of 0.9 mg/ml (43 mg and 30 mg total protein for WT and Mutant EPSPS) were determined using SDS-PAGE analysis and Bradford quantification.

### Example 1: Small Molecules' Inhibitory Effect on EPSP Synthase (EPSPS)

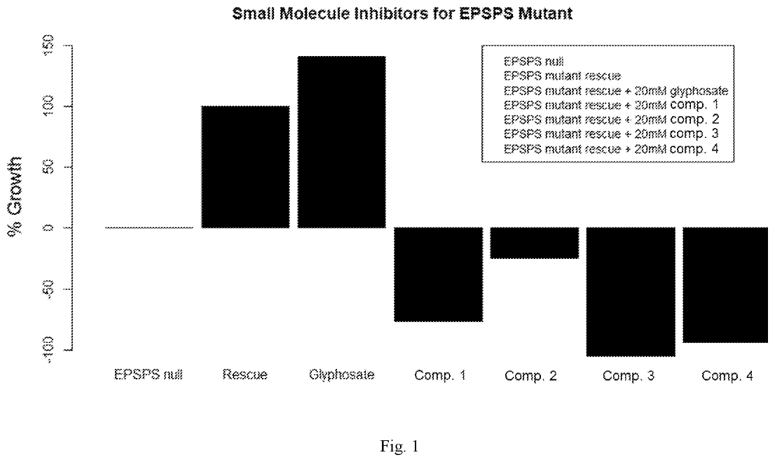

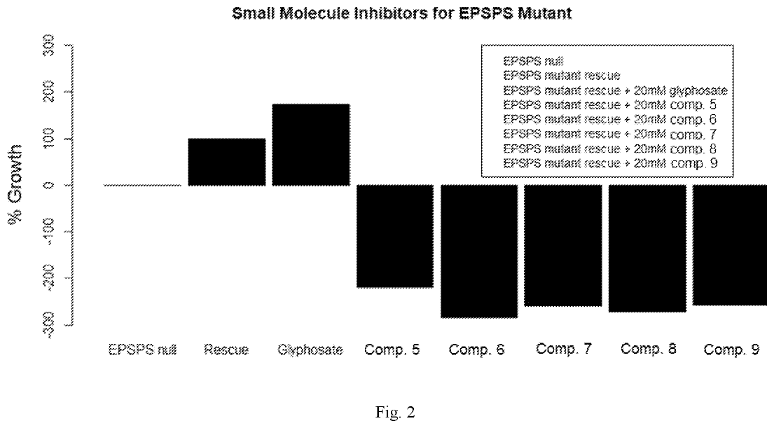

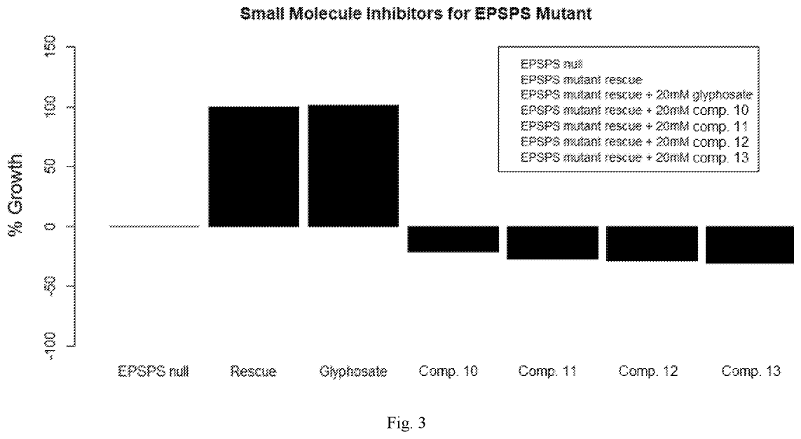

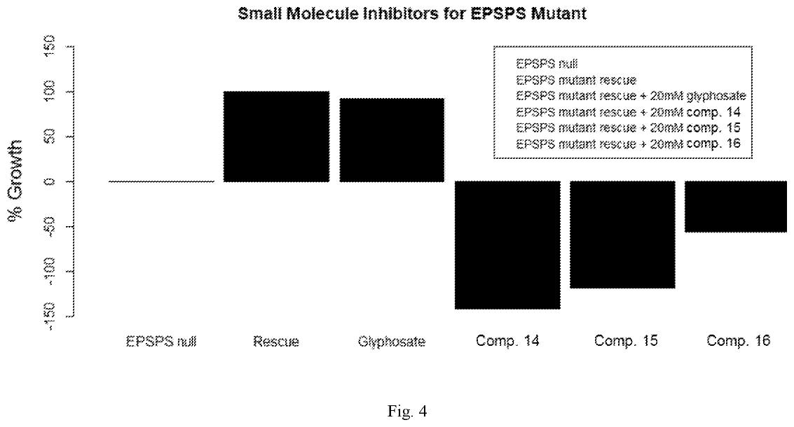

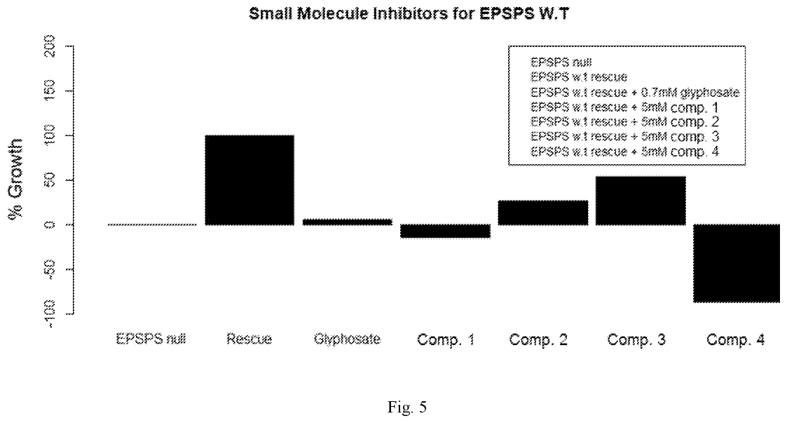

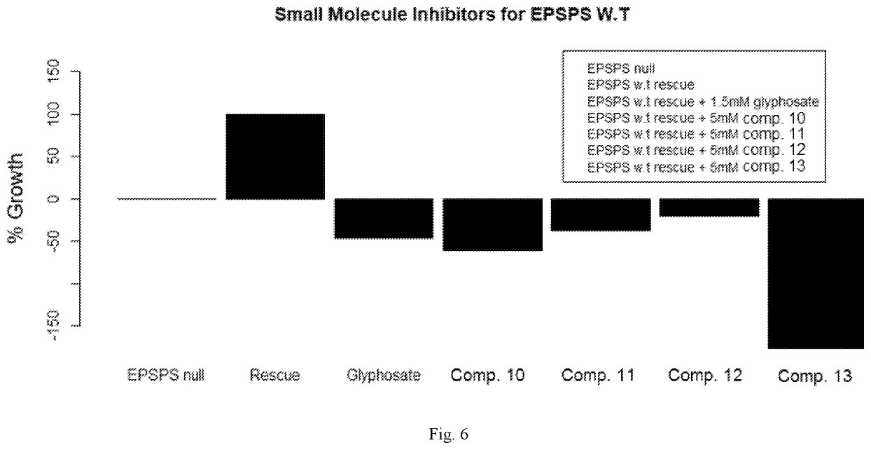

FIGS. 1-6 shows small molecule inhibitory effect on mutant EPSP Synthase (EPSPS), presented as bacterial growth of E. coli line AB2829. The AB2829 line carries a null mutation in the aroA gene that encodes for EPSPS. We have stably transformed this line with a vector expressing common wheat (Triticum Aestivum) EPSPS under the control of a rhamnose inducible promoter. When grown on M9 minimal media without rhamnose the bacteria are unable to grow (EPSPS null). However, inducing the expression of EPSPS TIPS mutant (FIGS. 1-4) or that of EPSPS wild type (FIGS. 5-6), from common wheat (Triticum Aestivum) in E. coli bacterial line AB2829 using 0.1% rhamnose supplemented at time=0, rescues the growth phenotype (Rescue) enabling bacterial growth on M9 minimal media. A screen for small molecules that can inhibit the growth of AB2829 bacteria under this condition (Rescue+small molecule, both applied at time=0) was performed in order to find EPSPS specific inhibitors. FIGS. 1-4 presents the inhibitory effect of 16 small molecules that their activity at 20 mM on the EPSPS TIPS mutant outperforms glyphosate's activity when applied at the same concentration. These results suggest that while the TIPS mutant is indifferent to glyphosate at 20 mM the 16 compounds can bypass the resistance to glyphosate exhibited by the TIPS mutant. FIGS. 5-6 demonstrates that the same compounds exert a similar inhibitory effect also on wild type EPSPS.

Molecules which outperformed glyphosate in inhibiting the TIPS mutant are listed below in Table 1, as compounds of Formula (I) and Formula (II).

TABLE 1
Chemical Structure of EPSPS-Inhibitory Compounds of Formula (I) and Formula (II)

| Comp. # | Chemical Structure | Chemical Name | CAS# |
|---|---|---|---|
| 1 | 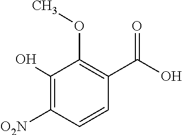 | 3-Hydroxy-2-methoxy-4- nitrobenzoic acid | 1312609-82-7 |
| 2 | 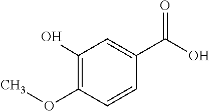 | 3-Hydroxy-4- methoxybenzoic acid | 645-08-9 |
| 3 | 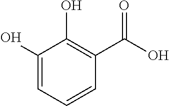 [SMILES: O=C(O)c1cccc(O)c1O] | 2,3-Dihydroxybenzoic acid | 303-38-8 |
| 4 | 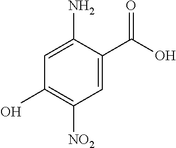 [SMILES: Nc1cc(O)c([N+](=O)[O-])cc1C(=O)O] | 2-Amino-4-hydroxy-5- nitrobenzoic acid | 574738-65-1 |
| 5 | 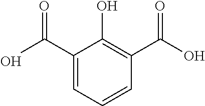 [SMILES: O=C(O)c1cccc(C(=O)O)c1O] | 2-Hydroxy-1,3- benzenedicarboxylic acid | 606-19-9 |
| 6 | 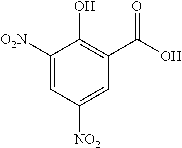 [SMILES: O=C(O)c1cc([N+](=O)[O-])cc([N+](=O)[O-])c1O] | 2-Hydroxy-3,5- dinitrobenzoic acid | 609-99-4 |
| 7 | 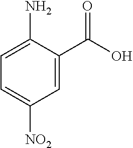 [SMILES: Nc1ccc([N+](=O)[O-])cc1C(=O)O] | 2-Amino-5-nitrobenzoic acid | 616-79-5 |
| 8 | 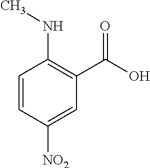 | -(Methylamino)-5- nitrobenzoic acid | 3484-33-1 |
| 9 | 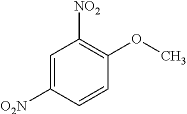 | 2,4-Dinitro-1- methoxybenzene | 119-27-7 |
| 10 | 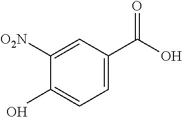 [SMILES: O=C(O)c1ccc(O)c([N+](=O)[O-])c1] | 4-Hydroxy-3-nitrobenzoic acid | 616-82-0 |
| 11 | 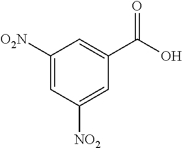 [SMILES: O=C(O)c1cc([N+](=O)[O-])cc([N+](=O)[O-])c1] | 3,5-Dinitrobenzoic acid | 99-34-3 |
| 12 | 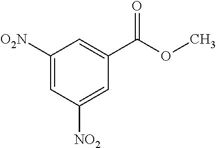 [SMILES: COC(=O)c1cc([N+](=O)[O-])cc([N+](=O)[O-])c1] | 3,5-Dinitrobenzoic acid methyl ester | 2702-58-1 |
| 13 | 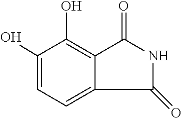 [SMILES: O=C1NC(=O)c2c1ccc(O)c2O] | 4,5-Dihydroxyisoindoline- 1,3-dione | 153356-72-0 |
| 14 | 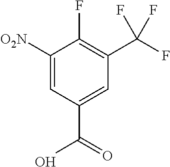 [SMILES: O=C(O)c1cc([N+](=O)[O-])c(F)c(C(F)(F)F)c1] | 4-Fluoro-3-nitro-5- (trifluoromethyl)benzoic acid | 878572-17-9 |
| 15 | 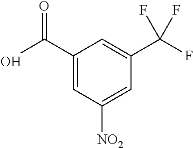 [SMILES: O=C(O)c1cc([N+](=O)[O-])cc(C(F)(F)F)c1] | 3-Nitro-5-(trifluoromethyl) benzoic acid | 328-80-3 |
| 16 | 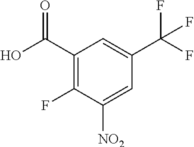 [SMILES: O=C(O)c1cc(C(F)(F)F)cc([N+](=O)[O-])c1F] | 2-Fluoro-3-nitro-5- (trifluoromethyl)benzoic acid | 1389313523 |

The percentages of rescued bacterial growth measured in mutant EPSPS (TIPS) samples (FIGS. 1-4) and Wild Type (FIGS. 5-6) are summarized below in Table 2.

TABLE 2
Percentage of Bacterial Growth Relative to Rescue with Mutant EPSPS at
20 mM, 40 hours Post Application and Wild Type EPSPS at 5 mM, 40 h post application

| | | | % bacterial |
|---|---|---|---|
| | | % bacterial growth | growth relative to |
| | | relative to rescue with | rescue with wild |
| | | mutant EPSPS at | type EPSPS at |
| | | 20 mM, 40 h post | 5 mM, 40 h post |
| Comp. # | Chemical Structure | application | application |
| Glyphosate | 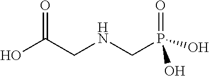 | +127% (+/−37%) | +6.0% (0.7 mM) −46% (1.5 mM) |
| 1 | 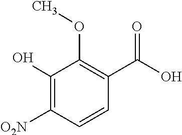 | −79% | −15% |
| 2 | 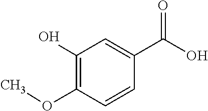 | −25% | 27% |
| 3 | 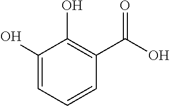 [SMILES: O=C(O)c1cccc(O)c1O] | −105% | 54% |
| 4 | 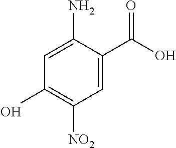 [SMILES: Nc1cc(O)c([N+](=O)[O-])cc1C(=O)O] | −94% | −87% |
| 5 | 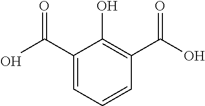 [SMILES: O=C(O)c1cccc(C(=O)O)c1O] | −220% | n.d. |
| 6 | 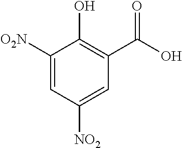 [SMILES: O=C(O)c1cc([N+](=O)[O-])cc([N+](=O)[O-])c1O] | −285% | n.d. |
| 7 | 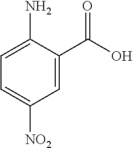 [SMILES: Nc1ccc([N+](=O)[O-])cc1C(=O)O] | −260% | n.d. |
| 8 | 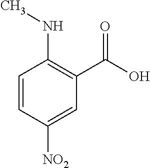 | −272% | n.d. |
| 9 | 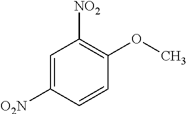 | −256% | n.d. |
| 10 | 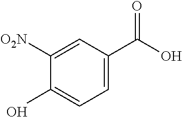 [SMILES: O=C(O)c1ccc(O)c([N+](=O)[O-])c1] | −21% | −61% |
| 11 | 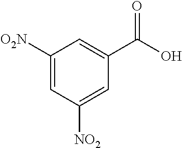 [SMILES: O=C(O)c1cc([N+](=O)[O-])cc([N+](=O)[O-])c1] | −27% | −38% |
| 12 | 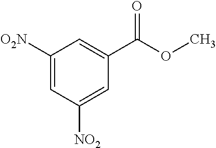 [SMILES: COC(=O)c1cc([N+](=O)[O-])cc([N+](=O)[O-])c1] | −29% | n.d. |
| 13 | 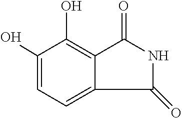 [SMILES: O=C1NC(=O)c2c1ccc(O)c2O] | −31% | −20% |
| 14 | 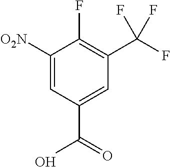 [SMILES: O=C(O)c1cc([N+](=O)[O-])c(F)c(C(F)(F)F)c1] | −142% | n.d. |
| 15 | 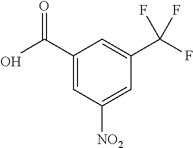 [SMILES: O=C(O)c1cc([N+](=O)[O-])cc(C(F)(F)F)c1] | −118% | −177% |
| 16 | 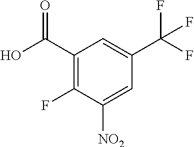 [SMILES: O=C(O)c1cc(C(F)(F)F)cc([N+](=O)[O-])c1F] | −56% | n.d. |

*n.d—not determined

We surprisingly found that a series of aromatic compounds of Formula (I) and Formula (II) inhibit EPSPS enzyme and/or other enzymes via the shikimate binding site. Compounds 1-16 are shown for the first time to modulate EPSPS enzymatic activity.

### Example 2: EPSP Synthase (EPSPS) Mutant TIPS Resist the Inhibition Caused by Compounds of Formula (I) in a Concentration Dependent Manner

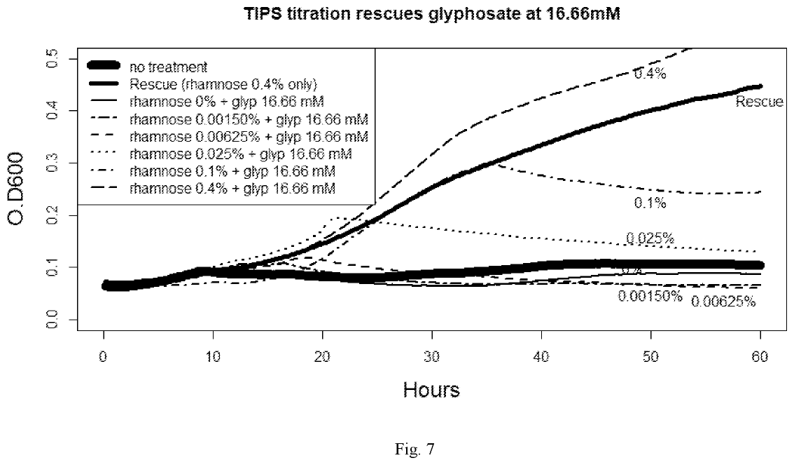

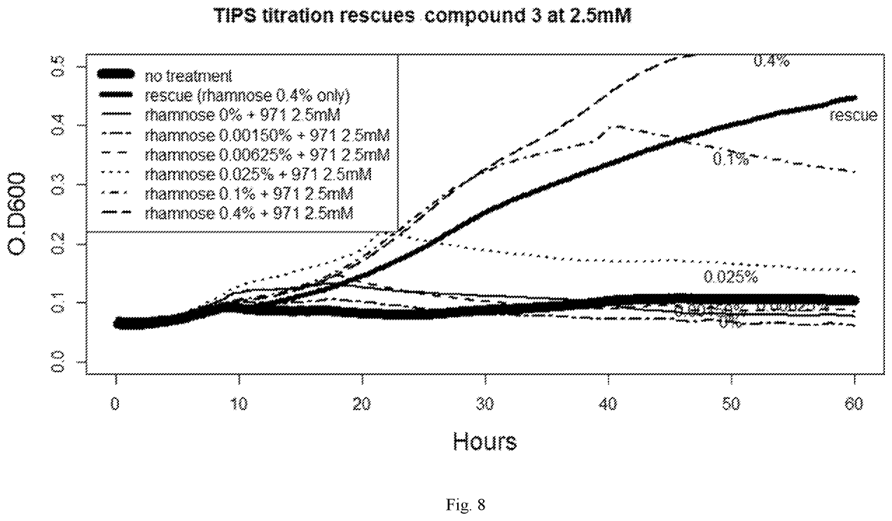

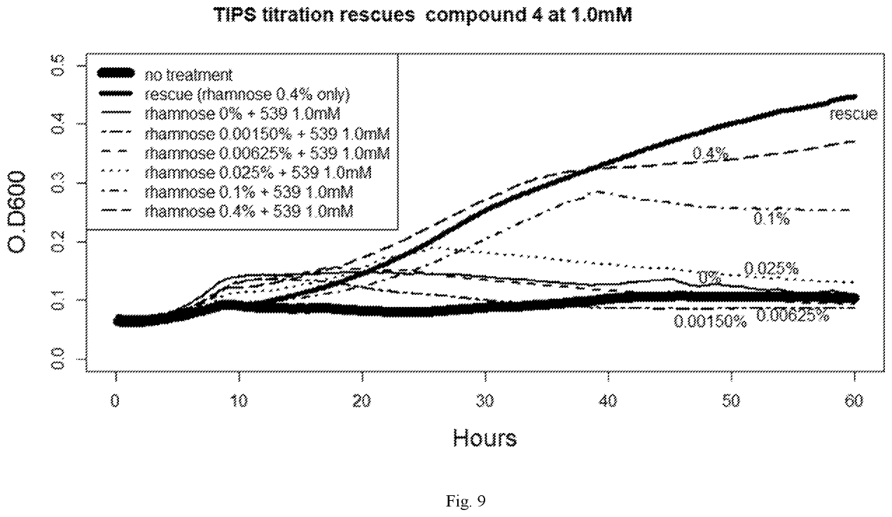

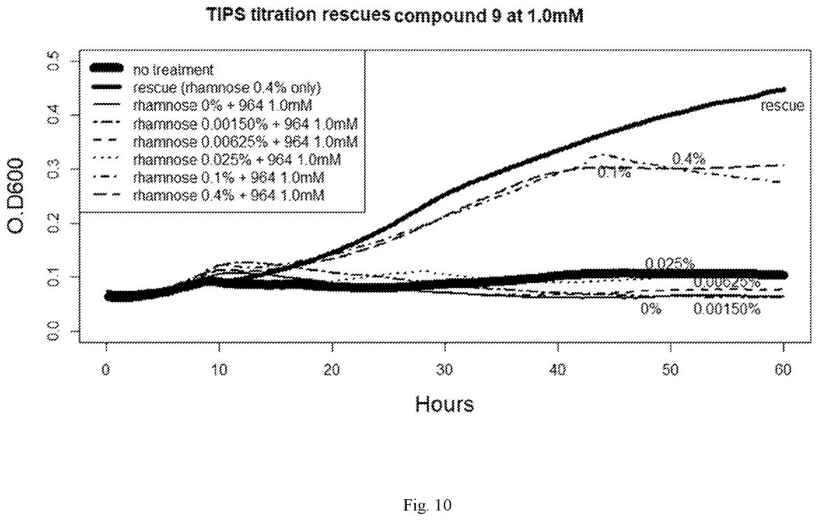

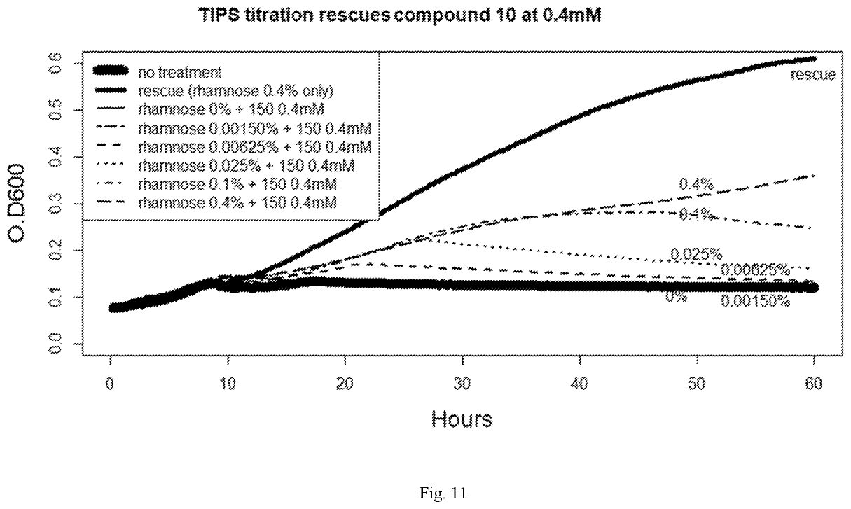

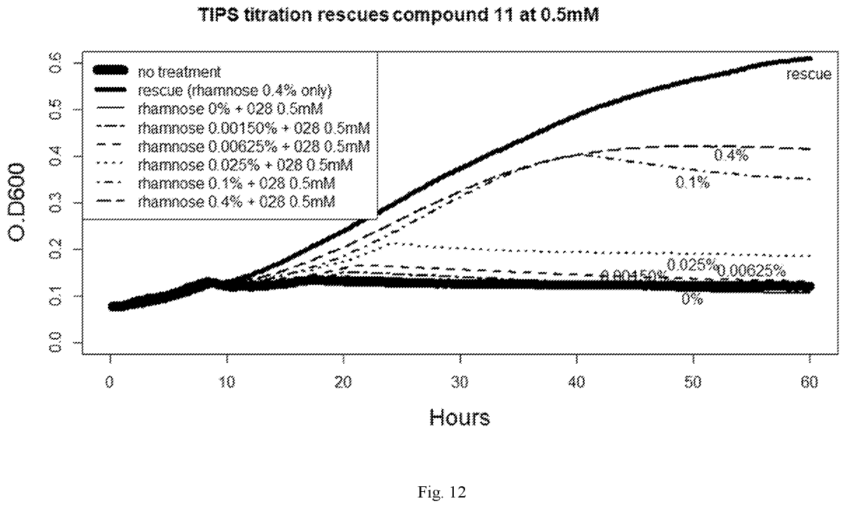

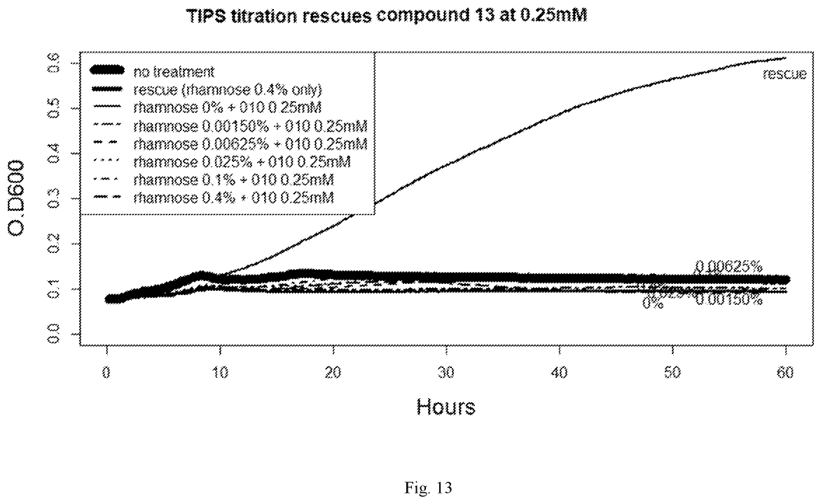

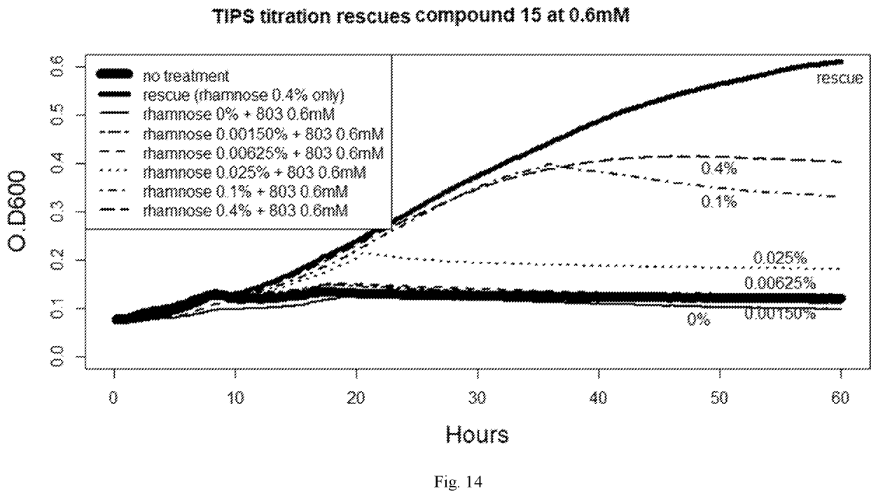

FIGS. 7-14 shows the ability of mutant EPSP Synthase (EPSPS), expressed in bacterial cells at gradually increasing concentrations, to resist the inhibitory effect of small molecules applied to the cell at a single, otherwise inhibitory, dose. The level of resistance that mutant EPSP Synthase (EPSPS) confers to the cell is presented as continuous bacterial growth of E. coli line AB2829. The AB2829 line carries a null mutation in the aroA gene that encodes for EPSPS. We have stably transformed this line with a vector expressing common wheat (Triticum Aestivum) EPSPS TIPS under the control of a rhamnose inducible promoter. When grown on M9 minimal media without rhamnose the bacteria are unable to grow (no treatment). Inducing the levels of EPSPS (TIPS mutant) from common wheat (Triticum Aestivum) in AB2829 bacteria, using 0.4% rhamnose rescues the growth phenotype (rescue). Gradually inducing the expression of EPSPS TIPS mutant using a range of rhamnose concentrations (0.0%-0.4%) supplemented at time=0 combined with a single inhibitory dose of glyphosate or one of the compounds of Formula (I) (FIGS. 7-14), gradually rescues the growth phenotype (rhamnose+small molecule) enabling bacterial growth on M9 minimal media in a gradual manner that correspond to the titration in EPSPS TIPS intracellular levels, even in the present of the inhibitor. These results suggest that similarly to glyphosate, compounds of Formula (I) and Formula (II) exert their inhibitory growth effect in a specific manner through EPSPS and the shikimate pathway. In case of compound 13, titration of TIPS couldn't rescue the growth phenotype suggesting it acts in a non-specific manner.

In cases where the rescue does not reach 60%-80%, we predict, without wishing to be bound by any theory, that the molecule may also bind to the shikimate kinase.

### Example 3: Efficacy Evaluation of 4 Molecules on Two Weeds Species, Lolium multiflorum (LOLMU) and Chenopodium album (CHEAL)

Weeds were grown on petri dishes containing two layers of sterile paper. Imbibition of 20 seeds was with various molecule solutions diluted in sterile water. Three replicates per condition—50, 500 and 5000 mg a.i./L. Observation of % germination and Visual notation performed 10 days after treatment (DAT). Technical Glyphosate was used as a reference. Results summarized in Table 3 below.

TABLE 3
Efficacy evaluation of 4 molecules on two weeds species, Lolium multiflorum (LOLMU) and
Chenopodium album (CHEAL) 10 DAT. Visual notation rage 0-as control, 100-

| | | | CHEAL | | | | LOLMU | | | |
|---|---|---|---|---|---|---|---|---|---|---|
| | | | Germination | | Visual | | Germination | | | |
| | | Dose | (%) | | notation | | (%) | | Visual notation | |
| Class | Treatment | (mg a.i./L) | Mean | s-d | Mean | s-d | Mean | s-d | Mean | s-d |
| | Control | 0 | 69.0 | 3.6 | 22.9 | 3.3 | 97.6 | 3.4 | 0.0 | 0.0 |
| 9 | 1-methoxy-2,4- | 50 | 73.8 | 7.9 | 41.7 | 7.1 | 95.6 | 3.1 | 3.8 | 1.7 |
| | dinitrobenzene | 500 | 63.6 | 11.8 | 53.1 | 3.5 | 85.9 | 15.5 | 76.3 | 9.5 |
| | | 5000 | 18.9 | 4.4 | 94.3 | 0.9 | 0.0 | 0.0 | 100.0 | 0.0 |
| 8 | 2-(methylamino)-5- | 50 | 90.0 | 4.1 | 21.8 | 11.3 | 93.2 | 5.4 | 3.5 | 3.0 |
| | nitrobenzoic acid | 500 | 55.0 | 14.1 | 83.8 | 0.5 | 91.1 | 3.1 | 6.6 | 0.9 |
| | | 5000 | 34.5 | 2.2 | 95.0 | 0.0 | 30.4 | 2.8 | 64.8 | 6.4 |
| | 3,5-dinitrobenzoic | 50 | 73.3 | 2.4 | 38.8 | 6.2 | 82.2 | 11.3 | 29.4 | 4.9 |
| 11 | acid | 500 | 66.1 | 4.4 | 39.4 | 6.0 | 95.6 | 6.3 | 73.0 | 0.7 |
| | | 5000 | 37.6 | 7.2 | 88.7 | 3.8 | 82.2 | 3.1 | 77.7 | 0.6 |
| | 4-hydroxy-3- | 50 | 68.8 | 9.0 | 52.4 | 7.7 | 95.6 | 6.3 | 18.4 | 3.5 |
| 10 | nitrobenzoic acid | 500 | 81.7 | 8.5 | 54.4 | 3.0 | 95.6 | 3.1 | 31.8 | 6.4 |
| | | 5000 | 56.7 | 6.2 | 76.5 | 7.2 | 95.6 | 6.3 | 54.0 | 0.9 |

### Example 4: In-Vitro Kinetics of EPSPS Enzymatic Activity in the Presence of Glyphosate

In-vitro kinetics of EPSPS enzymatic activity: EPSPS activity was determined by calorimetric quantification of inorganic phosphate release using Malachite green reagent. Reaction was performed using 0.5 μg enzyme in final a volume of 56 μl in 50 mM HEPES buffer pH 7.0 at 28° c. Reaction was allowed to develop for 20 sec for WT and 5 min for TIPS before it was stopped. For extraction glyphosate and compound 4 Kᵢ and IC₅₀ S3P and PEP concentrations were set at 1 mM, respectively, with PEP and S3P concentrations ranging from 0.015 mM to 2 mM, respectively.

Analysis of Michaelis-Menten kinetics without inhibitor or in the presence of 0.08 M-5.25 μM of glyphosate for WT EPSPS (A, Upper panel) and 160 μM-10250 μM of glyphosate for TIPS mutant (A, Lower panel) determined Kᵢ values of 458 nM and 459,123 nM, respectively. Extraction of IC₅₀ values also indicate that glyphosate's inhibition of WT EPSPS activity is 3 orders of magnitude stronger than its ability to inhibit EPSPS in the presence of the TIPS mutation. Analysis of Michaelis-Menten and Lineweaver-Burk plots clearly validates that glyphosate is a competitive inhibitor of EPSPS by showing that increased glyphosate concentrations result in increased PEP's Kₘ (apparent Kₘ) (B) without effecting the Vₘₐₓ of the reaction (C).

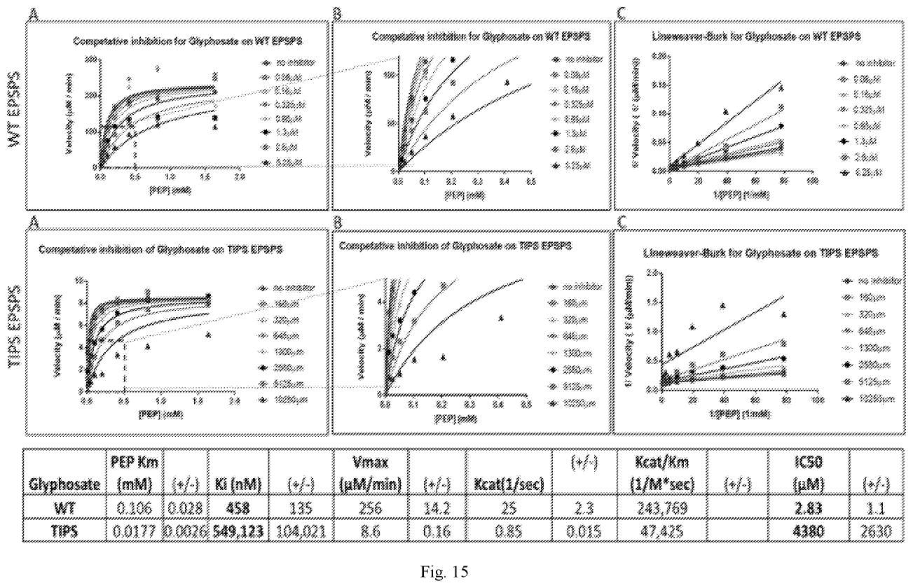

FIG. 15 shows that glyphosate is a competitive inhibitor of EPSPS

### Example 5: In-Vitro Kinetics of EPSPS Enzymatic Activity in the Presence of Compound 4

In-vitro kinetics of EPSPS enzymatic activity: EPSPS activity was determined by calorimetric quantification of inorganic phosphate release using Malachite green reagent. Reaction was performed using 0.5 μg enzyme in final a volume of 56 μl in 50 mM HEPES buffer pH 7.0 at 28° c. Reaction was allowed to develop for 20 sec for WT and 5 min for TIPS before it was stopped. For extraction glyphosate and compound 4 Kᵢ and IC₅₀ S3P and PEP concentrations were set at 1 mM, respectively, with PEP and S3P concentrations ranging from 0.015 mM to 2 mM, respectively.

Analysis of Michaelis-Menten kinetics without inhibitor or in the presence of 25 μM-1640 μM of compound 4 for WT EPSPS (A, Upper panel) and 50 μM-3280 μM of compound 4 for TIPS mutant (A, Lower panel) determined Kᵢ values of 44,035 nM and 57,382 nM, respectively. Extraction of IC₅₀ values also indicate that compound 4 ability to inhibit WT EPSPS activity is hardly affected by the presence of the TIPS mutation. Analysis of both Michaelis-Menten and Lineweaver-Burk plots clearly validates the computationally suggested mechanism of action of the shikimate analog, according to which compound 4 is a competitive inhibitor of EPSPS that binds to the shikimate binding site in the enzyme. This is indicated by the increase in S3P's Kₘ(apparent Kₘ) (B), which is correlated to the increase in compound 4 concentrations, together with the lack of effect observed on the Vₘₐₓ of the reaction (C).

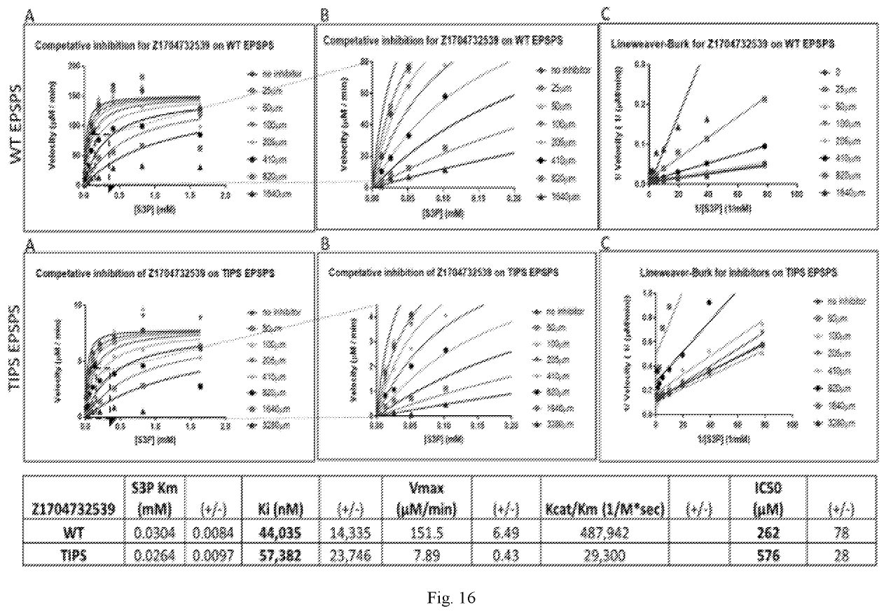

FIG. 16 indicates that compound 4 is a competitive inhibitor of EPSPS

### Example 6: Inhibition Glyphosate Vs. Compound 4 on TIPS Mutation

Direct comparison of glyphosate vs. compound 4 inhibition of WT and TIPS EPSPS demonstrate that relative to glyphosate (IC₅₀ WT=2.8 μM vs. IC₅₀ TIPS=4381 μM), compound 4 is one order of magnitude better then glyphosate in inhibiting the TIPS mutant, since it is indifferent to the presence of TIPS mutation (IC₅₀ WT=262 μM vs. IC₅₀ TIPS=576 μM). This indifference exhibited by compound 4 to the TIPS mutation relative to WT, is expected and consistent with the validated mechanism of action—competitive inhibitor of S3P

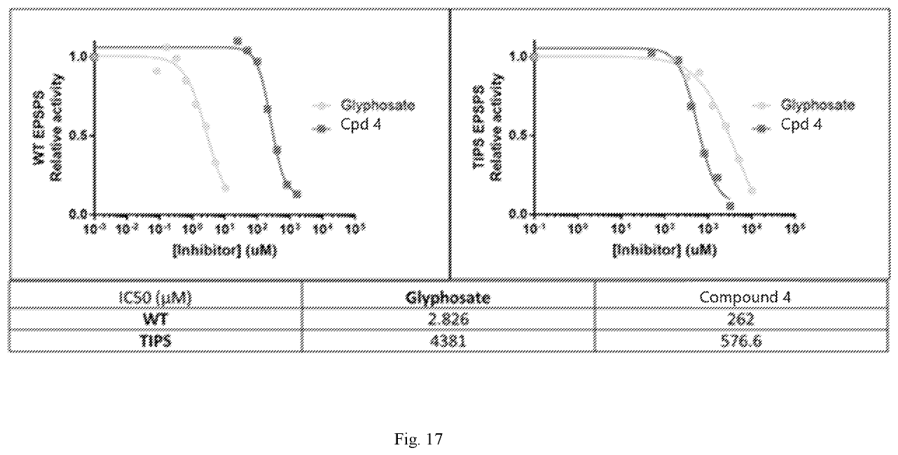

FIG. 17 shows that compound 4 is superior to glyphosate in the presence of the TIPS mutation

### Example 7: Inhibition of of Bacterial Growth with a Mixture of Glyphosate

Inhibitory effect of Glyphosate and compound 4 on mutant EPSP Synthase (TIPS EPSPS), presented as inhibition of bacterial growth of E. coli line AB2829. The AB2829 line carries a null mutation in the aroA gene that encodes for EPSPS. We have stably transformed this line with a vector expressing common wheat (Triticum Aestivum) EPSPS under the control of a rhamnose inducible promoter. When grown on M9 minimal media without rhamnose the bacteria are unable to grow (No rescue) (set as 100% growth inhibition). However, inducing the expression of the TIPS mutant using 0.1% rhamnose rescues the growth phenotype (Rescue) enabling bacterial growth on M9 minimal media (set as 0% growth inhibition). Under the same rescue conditions, the inhibitory effect of four low glyphosate doses 0.1, 0.5, 1.0 and 2.5 mM and one higher 25.0 mM dose, which is close to glyphosate's IC50, was tested (Glyphosate IC50 on TIPS mutant was determined to be ˜20-25 mM in this system at t=20-40 hours post rhamnose induction). In addition, the inhibitory effect of a single 2.5 mM dose of compound 4 was tested either individually vs. glyphosate (Upper panel) or in combination with all five glyphosate concentrations tested (Lower panel).

TABLE 4
Compound 4 level of inhibition

| | Growth |
|---|---|
| | Inhibition (%) |
| Compound 4 Vs. Glyphosate | |
| No Rescue (No inhibitor) | 0 |
| Rescue (No Inhibitor) | 100 |
| Comp.4 2.5 mM | 71 |
| Gly 0.1 mM | −14 |
| Gly 0.5 mM | −16 |
| Gly 1.0 mM | 3 |
| Gly 2.5 mM | 34 |
| Gly 25 mM | 66 |
| Compound 4 Combined | |
| with Glyphosate | |
| No Rescue (No Inhibitor) | 0 |
| Rescue (No inhibitor) | 100 |
| Comp.4 2.5 mM | 71 |
| Comp.4 2.5 mM + Gly 0.1 mM | 70 |
| Comp.4 2.5 mM + Gly 0.5 mM | 79 |
| Comp.4 2.5 mM + Gly 1.0 mM | 92 |
| Comp.4 2.5 mM + Gly 2.5 mM | 103 |
| Comp.4 2.5 mM + Gly 25 mM | 164 |

Results from this experiment, quantified at t=15 h post rhamnose induction, indicate that that there is a synergistic effect between glyphosate and compound 4

Expected inhibition of Gly 1.0 Mm and Compound 4 at 2.5 Mm is 71.84, the observed inhibition is 92

1-76. (canceled)

77. A herbicidal, pesticidal, bactericidal, or fungicidal composition comprising as an active ingredient at least one compound of Formula (A): 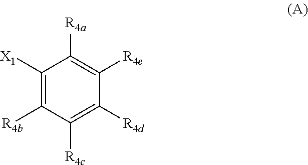
wherein:
X₁ is H, C₁-C₁₂ alkyl, OR₁, or COR₂,
wherein:
R₁ is H or C₁-C₁₀alkyl, and
R₂ is OH, C₁-C₁₀alkyl, or O-alkyl,
and
each of R₄ₐ, R_{4b}, R_{4c}, R_{4d}, and R₄ₑ is, independently, H, C₁-C₃ alkyl, OR₅, COR₆, NO₂, F, CH₂F, CHF₂, CF₃, or NR₇R₈,
wherein:
R₅ is H or C₁-C₃ alkyl,
R₆ is OH,
R₇ is H or C₁-C₃ alkyl, and
R₈ is H or C₁-C₃ alkyl,
or R₄ₑ forms a five-membered fused ring with R_{4d},
or a salt thereof; and an agriculturally acceptable carrier.

78. The composition of claim 77, wherein X₁ is COR₂.

79. The composition of claim 78, wherein R₂ is OH.

80. The composition of claim 77, wherein each of R₄ₐ, R_{4b}, R_{4c}, R_{4d}, and R₄ₑ is, independently, H, OR₅, COR₆, NO₂, F, CF₃, or NR₇R₈.

81. The composition of claim 80, wherein R₅ is H or CH₃.

82. The composition of claim 77, wherein R₇ and R₈ are each H.

83. The composition of claim 77, wherein the compound is selected from: 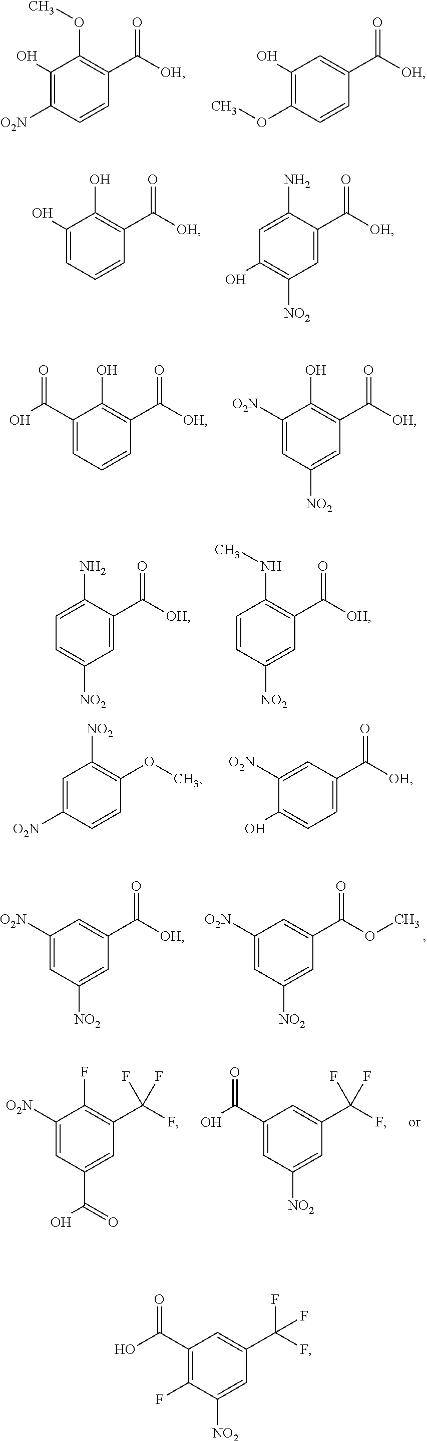
or a salt thereof.

84. The composition of claim 77, wherein the compound is 2-amino-4-hydroxy-5-nitrobenzoic acid.

85. A herbicidal, pesticidal, bactericidal, or fungicidal composition comprising as an active ingredient at least one compound of Formula (II): 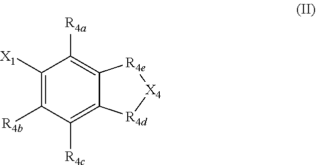
wherein:
X₁ is H, C₁-C₁₂ alkyl, OR₁, COR₂, SR₁, NO₂, halogen, CH₂F, CHF₂, CF₃, N—(—R₃)₂, CN, SO₂R₂, or 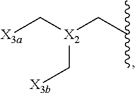
wherein:
R₁ is H, C₁-C₁₀alkyl, C₂-C₁₀alkenyl, C₂-C₁₀ alkynyl, CO—C₁-C₁₀ alkyl, CO—C₂-C₁₀ alkenyl, CO—C₂-C₁₀ alkynyl, or C(O)N—(—H, C₁-C₁₀ alkyl, C₂-C₁₀ alkenyl, and/or C₂-C₁₀ alkynyl)₂,
R₂ is OH, C₁-C₁₀ alkyl, C₂-C₁₀ alkenyl, C₂-C₁₀ alkynyl, O—C₁-C₁₀ alkyl, O—C₂-C₁₀ alkenyl, O—C₂-C₁₀ alkynyl, or N—(—H, C₁-C₁₀ alkyl, C₂-C₁₀ alkenyl, and/or C₂-C₁₀ alkynyl)₂,
R₃ is H, C₁-C₁₀ alkyl, C₂-C₁₀ alkenyl, C₂-C₁₀ alkynyl, SO₂—R₂, CO₂—C₁-C₁ alkyl, CO₂—C₂-C₁₀ alkenyl, or CO₂—C₂-C₁₀ alkynyl,
X₂ is CH or N, and
each of X₃ₐ and X_{3b} is, independently, COOH, PO₃H₂, or NO₂;
each of R₄ₐ, R_{4b}, and R_{4c} is, independently, H, C₁-C₃ alkyl, C₂-C₃ alkenyl, C₂-C₃ alkynyl, OR₅, COR₆, SR₅, NO₂, halogen, CH₂F, CHF₂, CF₃, NR₇R₈, CN, or SO₂R₆,
wherein:
R₅ is H, C₁-C₃ alkyl, C₂-C₃ alkenyl, C₂-C₃ alkynyl, CO—C₁-C₃ alkyl, CO—C₂-C₃ alkenyl, CO—C₂-C₃ alkynyl, or C(O)N—(—H, C₁-C₃ alkyl, C₂-C₃ alkenyl, and/or C₂-C₃ alkynyl)₂,
R₆ is OH, C₁-C₃ alkyl, C₂-C₃ alkenyl, C₂-C₃ alkynyl, 0-C₁-C₃ alkyl, O—C₂-C₃ alkenyl, O—C₂-C₃ alkynyl, or N—(—H, C₁-C₃ alkyl, C₂-C₃ alkenyl, and/or C₂-C₃ alkynyl)₂,
R₇ is H, C₁-C₃ alkyl, C₂-C₃ alkenyl, C₂-C₃ alkynyl, SO₂—R₆, CO₂—C₁-C₃ alkyl, CO₂—C₂-C₃ alkenyl, or CO₂—C₂-C₃ alkynyl, and
R₈ is H, C₁-C₃ alkyl, C₂-C₃ alkenyl, C₂-C₃ alkynyl, SO₂—R₆, CO₂—C₁-C₃ alkyl, CO₂—C₂-C₃ alkenyl, or CO₂—C₂-C₃ alkynyl,
each of R_{4d}, R₄ₑ, and X₄ is, independently, C(R₉)₂, C(O), NR₉, O, S, SO, or SO₂,
wherein
R₉ is H, OH, O—C₁-C₃ alkyl, O—C₂-C₃ alkenyl, O—C₂-C₃ alkynyl, C₁-C₃ alkyl, C₂-C₃ alkenyl, or C₂-C₃ alkynyl;
or a salt thereof; and an agriculturally acceptable carrier.

86. The composition of claim 85, wherein the compound is: 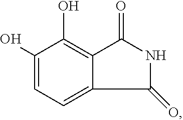 [SMILES: O=C1NC(=O)c2c1ccc(O)c2O]
or a salt thereof.

87. The composition of claim 77, wherein the concentration of the at least one compound of Formula (A) in the composition is from 5 wt. % to 50 wt. %.

88. The composition of claim 87, wherein the composition is in the form of a tablet, water dispersible granule, wettable powder, suspension concentrate, emulsifiable concentrate, microemulsion, oil dispersion, soluble liquid, capsule suspension, or soluble granule.

89. The composition of claim 77, further comprising glyphosate.

90. A method for the control or prevention of at least one pest in a crop field, comprising applying a pesticidally effective amount of the composition of claim 77 to the pest, a locus of the pest, and/or an area in which pest infestation is to be prevented so as to thereby control or prevent the pest in the crop field.

91. The method of claim 90, wherein the at least one compound of Formula (A) is applied at a rate from about 0.05 to 5000 g/ha; or wherein the at least one compound of Formula (A) is applied pre-plant incorporated; or wherein the at least one compound of Formula (A) is applied pre-emergence; or wherein the at least one compound of Formula (A) is applied post-emergence; or wherein the at least one compound of Formula (A) is applied early-post-emergence.

92. The method of claim 90, wherein the composition is applied by foliar application, broadcast, basal application, soil application, soil incorporation, or soil injection; or wherein the crop is glyphosate resistant; or wherein the crop is corn, wheat, soybean, rice, cotton, oilseed rape, barley, or sugar beet; or wherein the pest is monocotyledonous or dicotyledonous weed.

93. The method of claim 90, further comprising application of at least one additional pesticide.

94. The method of claim 93, wherein the at least one additional pesticide is a fungicide, herbicide, or insecticide; or wherein the at least one additional pesticide is applied jointly or in a succession with the composition; or wherein the at least one additional pesticide is tank mixed with the composition prior to application; or wherein the at least one additional pesticide is formulated with the composition; or wherein application of the composition and the at least one additional pesticide exhibits synergistic effect.

95. A method of inhibiting 5-enolpyruvylshikimate-3-phosphate synthase (EPSPS) comprising contacting the EPSPS with an effective amount of at least one compound of Formula (A) or a salt thereof as defined in claim 77.

96. A method of inhibiting shikimate kinase comprising contacting the shikimate kinase with an effective amount of at least one compound of Formula (A) or a salt thereof as defined in claim 77.
